(19) United States
(12) Patent Application Publication
(10) Pub. No.: US 2026/0028435 A1
(43) Pub. Date: Jan. 29, 2026

(54) Method of Synthesizing Olefin Functional Polymer in Continuous Feeding Manner and Use of the Olefin Functional Polymer

(71) Applicant: Jiangsu Yangnong Chemical Group Co., Ltd., Yangzhou, Jiangsu (CN)

(72) Inventors: Kehong DING, Yangzhou, Jiangsu (CN); Genlin WANG, Yangzhou, Jiangsu (CN); Yinghua ZHOU, Yangzhou, Jiangsu (CN); Cheng WANG, Yangzhou, Jiangsu (CN); Liuqiao ZHANG, Yangzhou, Jiangsu (CN); Qingchao NIE, Yangzhou, Jiangsu (CN)

(21) Appl. No.: 18/995,127

(22) PCT Filed: May 29, 2024
(86) PCT No.: PCT/CN2024/096139

§ 371 Date: Jan. 15, 2025

(30) Foreign Application Priority Data
May 29, 2023 (CN) 202310617195.3
Jun. 19, 2023 (CN) 202310727190.6

(51) Int. Cl. C08F 8/46; C08F 8/30; C08J 5/24; C08L 67/02; C08L 77/02; C09J 123/26

(52) U.S. Cl. CPC C08F 8/46; C08F 8/30; C08J 5/244; C08L 67/02; C08L 77/02; C09J 123/26; C08J 2323/16

(57) ABSTRACT

Provided is a method of synthesizing olefin functional polymer in a continuous feeding manner and use based on the olefin functional polymer. The method includes: introducing a low-carbon olefin into a reactor, then raising temperature and pressure, and adding a raw material solution prepared by a functional monomer, an initiator and a solvent into the reactor after reaction temperature and reaction pressure are reached to generate a polymerization reaction; and first performing gas-solid-liquid separation on a system after the reaction, recovering the low-carbon olefin, performing solid-liquid separation on a residual material to obtain an olefin functional polymer and a liquid-phase material. This application realizes alternating copolymerization of a low-carbon gaseous olefin and a functional monomer both in a same chain through a pressure reaction, adopts a heterogeneous polymerization mode to improve a monomer concentration and a raw material utilization rate, and synthesizes olefin functional polymers with different molecular weights.

### CROSS-REFERENCE TO RELATED APPLICATION

This application claims the priority of a Chinese patent application entitled “METHOD OF SYNTHESIZING OLEFIN FUNCTIONAL POLYMER IN CONTINUOUS FEEDING MANNER” with application number “202310617195.3”, submitted to the Chinese Patent Office on May 29, 2023, as well as the priority of a Chinese patent application entitled “USE OF AN OLEFIN FUNCTIONAL POLYMER” with application number “202310727190.6”, submitted to the Chinese Patent Office on Jun. 19, 2023, the entire contents of which are incorporated in this application by reference.

### TECHNICAL FIELD

The present application relates to the technical field of organic polymerization, and specifically to a method of synthesizing an olefin functional polymer in a continuous feeding manner and use of the olefin functional polymer.

### BACKGROUND

Olefin functional polymers, as functional polymer materials, have a wide range of applications in chain extension of engineering plastics, high-performance composite materials, nylon infiltration, ink dispersion, microencapsulation, and filter membrane formation, and have attracted great attention. There are a large number of active groups in the molecular chains of olefin functional polymers, which can react with various functional groups, such as the terminal hydroxyl or terminal amino group of nylon products, increasing the molecular weight of nylon, improving mechanical properties, and adjusting the viscosity value of nylon; in addition, olefin functional polymers can be used for the preparation of microcapsules and have good application prospects in the fields of pesticides, spices and drugs.

The raw materials for the synthesis of olefin functional polymers are mainly olefins and functional monomers. At present, the polymerization methods available include emulsion polymerization, suspension polymerization and precipitation polymerization. The first two methods require the use of a large number of stabilizers, which remain on polymer particles through physical adsorption or chemical adsorption, affecting their performance; and although precipitation polymerization does not require the addition of stabilizers, the low concentration of polymerization monomers in traditional precipitation polymerization systems results in low polymerization efficiency, thus requiring improvements in the polymerization method.

According to the different types of olefins or functional monomers in the types of raw materials for the synthesis of olefin functional polymers, corresponding synthesis processes need to be adopted. CN101235117A discloses a method of copolymerization of styrene/maleic anhydride. The method includes dissolving monomer maleic anhydride and styrene, an initiator of organic peroxide or an azo compound into a medium in a nitrogen atmosphere, and reacting at 60-90° C. for 0.25-12 h to obtain a dispersion system of polymer microspheres. CN102212166A discloses a new method of copolymerization of dicyclopentadiene and maleic anhydride. The method also includes dissolving a monomer and an initiator into an organic medium in a nitrogen atmosphere, and reacting at 60-90° C. for 2-12 h to obtain a self-stable dispersion system of alternating copolymer monodisperse microspheres, and then centrifuging and drying to obtain a white solid of a dicyclopentadiene/maleic anhydride alternating copolymer.

Both of the above-mentioned patents use maleic anhydride as a functional monomer to polymerize with an olefin, but the olefin used is usually an olefin of C4 or higher, and is usually a liquid olefin such as a diene, a cycloolefin, and an isomeric olefin, and the polymerization reaction of a gaseous olefin of C4 or lower is not involved. CN113388123A discloses a method of preparing high-viscosity nylon, which includes: mixing a nylon salt prepolymer and an olefin-maleic anhydride copolymer, and performing a polycondensation reaction to prepare high-viscosity nylon. Although the olefin-maleic anhydride copolymer used in the method can choose an ethylene-maleic anhydride alternating copolymer or the like, the process method of synthesizing the copolymer from a low-carbon olefin is not clear.

In summary, for the synthesis of olefin functional polymers, especially the polymerization of low-carbon olefins with C4 or less and functional monomers, it is also necessary to select an appropriate synthesis process according to the characteristics of raw materials to improve production efficiency and simplify separation processes, and reduce raw material and process costs.

### SUMMARY

In view of the problems existing in the prior art, one of the purposes of this application is to provide a method of synthesizing an olefin functional polymer in a continuous feeding manner. The method realizes alternating copolymerization of a low-carbon gaseous olefin and a functional monomer both in a same chain through a pressure reaction, and adopts a heterogeneous polymerization mode to improve a monomer concentration and a raw material utilization rate, and synthesizes olefin functional polymers with different molecular weights by adjusting process parameters, with a high reaction efficiency; and a post-treatment process is simple, separation and purification are easy, energy consumption is saved, and costs are reduced.

To achieve this purpose, in the first aspect of this application, this application adopts the following technical solutions:
this application provides a method of synthesizing an olefin functional polymer in a continuous feeding manner, including the following steps:
(1) introducing a low-carbon olefin into a reactor, then raising temperature and pressure, and adding a raw material solution prepared by a functional monomer, an initiator and a solvent into the reactor in the continuous feeding manner after reaction temperature and reaction pressure are reached to generate a polymerization reaction; and
(2) first performing gas-solid-liquid separation on a system after the polymerization reaction in step (1), recovering a low-carbon olefin, returning a discharged low-carbon olefin to step (1) for reuse, and performing solid-liquid separation on a residual material after discharge to obtain a solid-phase olefin functional polymer and a liquid-phase material.

In this application, for the synthesis of the olefin functional polymer, the selection of an olefin and the functional monomer has a significant impact on the performance of the polymer. The difference in the phase state between the two makes it relatively difficult for both the olefin and the functional monomer to be in a liquid form, and a low-carbon gaseous olefin usually does not contain side chains, making the reaction more difficult compared with a liquid olefin. This application selects the low-carbon gaseous olefin to react with a liquid functional monomer, increases a monomer concentration and a reaction rate, improves a raw material conversion rate and a product yield, and realizes the alternating copolymerization of a gaseous olefin monomer and a functional monomer in a same chain by a pressure reaction and heterogeneous polymerization. And the olefin functional polymers with different molecular weights are synthesized by adjusting process parameters. After polymerization, a relatively stable milky dispersion system can be directly obtained, and a post-treatment process is simple, separation and purification are easy; and the method is easy to operate, has mild reaction conditions and recyclable raw materials, saves energy consumption, has low costs, and is environmentally friendly.

In this application, a continuous feeding mode is adopted, the concentration of the monomer and the initiator in the reaction can be regulated and controlled in real time, the concentration of the monomer and the utilization rate of the raw material can be improved, the molecular weight of the olefin functional polymer can be regulated, the concentration of the initiator can be increased, polymerization pressure can be reduced, polymerization time can be shortened, and at the same time, the solvent can be recycled and reused, with obvious advantage. In this application, the reaction raw material is continuously added to the reactor, so the reaction in the reactor occurs continuously, but the reacted material is intermittently post-processed, so the olefin functional polymer is not continuously synthesized.

The following are preferred technical solutions of this application, but are not limited to the technical solutions provided in this application. Through the following technical solutions, the technical purposes and beneficial effects of this application can be better achieved and realized.

As a preferred technical solution of this application, the low-carbon olefin in step (1) includes any one or a combination of at least two of ethylene, propylene, butene, or butadiene, and typical but non-limiting examples of the combination include: a combination of ethylene and propylene, a combination of propylene and butene, a combination of ethylene, propylene and butene, and the like, where the butene includes an isomer such as 1-butene, 2-butene or isobutene.

Preferably, before introducing the low-carbon olefin in step (1), the reactor is evacuated and then replaced with a protective gas, and the protective gas can be selected from nitrogen or an inert gas.

As a preferred technical solution of this application, the reactor in step (1) includes any one of a reaction kettle, a tubular reactor, a microchannel reactor, a fluidized bed reactor, or a boiling bed reactor.

Preferably, the tubular reactor includes any one of a horizontal tubular reactor, a vertical tubular reactor, a coiled tubular reactor, or a U-shaped tubular reactor.

Preferably, the microchannel reactor includes a gas-liquid-solid three-phase catalytic microreactor.

In this application, the selection of the above-mentioned reactor types is based on whether the reactor can enhance the mixing, mass transfer and heat transfer processes of a polymerization process. For example, when a microchannel reactor is used, the heat and mass transfer efficiency is high and the reaction conditions are precisely controlled.

As a preferred technical solution of this application, the functional monomer in step (1) includes any one or a combination of at least two of maleic anhydride, maleimide or maleic acid, and typical but non-limiting examples of the combination include: a combination of maleic anhydride and maleimide, a combination of maleimide and maleic acid, a combination of maleic anhydride, maleimide and maleic acid, and the like.

Preferably, the initiator in step (1) includes an azo compound and/or a peroxide compound.

Preferably, the azo compound includes any one or a combination of at least two of azodiisobutyronitrile, azobisisovaleronitrile, azobisisoheptonitrile, azodicyclohexylformonitrile, or dimethyl azodiisobutyrate, and typical but non-limiting examples of the combination include: a combination of azodiisobutyronitrile and azobisisovaleronitrile, a combination of azodiisobutyronitrile and azobisisoheptonitrile, a combination of azodiisobutyronitrile, azobisisoheptonitrile and dimethyl azodiisobutyrate, a combination of azobisisovaleronitrile, azobisisoheptonitrile, dimethyl azodiisobutyrate, and the like.

Preferably, the peroxide compound includes any one or a combination of at least two of dibenzoyl peroxide, dicumyl peroxide, diisobutyryl peroxide, bis(2,4-dichlorobenzoyl) peroxide, dodecanoyl peroxide, tert-butyl peroxyneoheptanoate, tert-butyl peroxyneodecanoate, di-sec-butyl peroxydicarbonate, di(hexadecyl) peroxydicarbonate, tert-amyl peroxyneodecanoate, tert-butyl peroxypivalate, bis(4-tert-butylcyclohexyl) peroxydicarbonate, dicyclohexyl peroxydicarbonate, diisopropyl peroxydicarbonate, dibutyl peroxydicarbonate, bis(2-ethylhexyl) peroxydicarbonate, tert-butyl 2-ethylhexanoate peroxide, ditetradecyl peroxydicarbonate, tert-butyl peroxyacetate, cumyl peroxyneodecanoate, di-tert-butyl peroxide, cyclohexylsulfonylacetyl peroxide, 1,1,3,3-tetramethylbutyl peroxyneodecanoate, di-3-methoxybutyl peroxydicarbonate, or 1,1,3,3-tetramethylbutyl peroxypivalate, and typical but non-limiting examples of the combination include: a combination of dibenzoyl peroxide and dodecanoyl peroxide, a combination of dibenzoyl peroxide and dicumyl peroxide, a combination of dodecanoyl peroxide, dicumyl peroxide and diisopropyl peroxydicarbonate, and the like.

Preferably, the solvent in step (1) includes any one or a combination of at least two of an organic alkanoate compound, an alkane compound or an aromatic hydrocarbon compound, and typical but non-limiting examples of the combination include: a combination of an organic alkanoate compound and an alkane compound, a combination of an alkane compound and an aromatic hydrocarbon compound, a combination of an organic alkanoate compound, an alkane compound and an aromatic hydrocarbon compound, and the like.

Preferably, a general formula of the organic alkanoate compound is

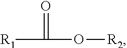

where R1 is any one of H, a C1-C20 alkane group or a C6-C10 aryl group, and R2 is any one of a C1-C20 alkane group or a C6-C10 aryl group.

Preferably, the organic alkanoate compound includes ethyl formate, propyl formate, isobutyl formate, amyl formate, ethyl acetate, butyl acetate, isobutyl acetate, amyl acetate, isoamyl acetate, benzyl acetate, phenyl acetate, methyl propionate, ethyl propionate, propyl propionate, butyl propionate, methyl butyrate, ethyl butyrate, propyl butyrate, butyl butyrate, isobutyl butyrate, isoamyl butyrate, ethyl isobutyrate, ethyl isovalerate, isoamyl isovalerate, methyl benzoate, ethyl benzoate, propyl benzoate, butyl benzoate, isoamyl benzoate, methyl phenylacetate, ethyl phenylacetate, propyl phenylacetate, butyl phenylacetate, or isoamyl phenylacetate, and typical but non-limiting examples of the combination include: a combination of ethyl acetate and butyl acetate, a combination of propyl formate and ethyl acetate, a combination of ethyl acetate, ethyl propionate and ethyl butyrate, and the like.

Preferably, the alkane compound includes any one or a combination of at least two of cyclohexane, n-hexane, n-heptane, n-pentane, n-octane, or n-decane, and typical but non-limiting examples of the combination include: a combination of cyclohexane and n-hexane, a combination of n-hexane and n-heptane, a combination of n-hexane and n-heptane, a combination of cyclohexane, n-hexane and n-heptane, and the like.

Preferably, the aromatic hydrocarbon compound includes any one or a combination of at least two of benzene, toluene, ethylbenzene, or xylene, and typical but non-limiting examples of the combination include: a combination of benzene and ethylbenzene, a combination of benzene and toluene, a combination of toluene and ethylbenzene, a combination of ethylbenzene and xylene, a combination of benzene, ethylbenzene and xylene, and the like.

As a preferred technical solution of this application, a molar ratio of the initiator to the functional monomer in step (1) is (0.001-0.2):1, for example, 0.001:1, 0.005:1, 0.01:1, 0.05:1, 0.1:1, 0.15:1, or 0.2:1, etc., but is not limited to the numerical values listed, and other numerical values not listed within the numerical range are equally applicable, preferably (0.001-0.03):1.

Preferably, a mass ratio of the solvent to the functional monomer in step (1) is (2-50):1, for example, 2:1, 5:1, 10:1, 20:1, 25:1, 30:1, 35:1, 40:1, or 50:1, etc., but is not limited to the numerical values listed, and other numerical values not listed within the numerical range are equally applicable, preferably (2-10):1.

Preferably, before adding the raw material solution into the reactor in step (1), impurity removal and preheating are performed.

In this application, the raw material solution needs to be preheated before feeding to ensure sufficient dissolution and no precipitation of the monomer in the system; and at the same time, a preheating temperature should not be too high, causing premature decomposition and consumption of the initiator. For the formation of the raw material solution, it is necessary to mix components.

If there are undissolved impurities after mixing, filtering and other operations should be used to remove the undissolved impurities first.

Preferably, the raw material solution in step (1) is pumped into the reactor at a constant speed after being pressurized by a transfer pump.

In this application, the raw material solution is continuously introduced and discharged after the residence time is reached to ensure the continuous progress of the reaction, and a discharged material after the reaction are then subjected to subsequent separation and rectification processes.

As a preferred technical solution of this application, a temperature of the polymerization reaction in step (1) is 50-150° C., for example, 50° C., 60° C., 70° C., 75° C., 80° C., 90° C., 100° C., 110° C., 120° C., or 150° C., etc., but is not limited to the numerical values listed, and other numerical values not listed within the numerical range are equally applicable, preferably 70-120° C.

Preferably, pressure of the polymerization reaction in step (1) is 0.1-10 MPa, for example, 0.1 MPa, 0.5 MPa, 1 MPa, 3 MPa, 5 MPa, 6 MPa, 8 MPa, or 10 MPa, but is not limited to the numerical values listed, and other numerical values not listed within the numerical range are equally applicable, preferably 2-8 MPa.

Preferably, feeding time of the raw material solution in step (1) is 0.1-10 h, for example, 0.1 h, 0.5 h, 1 h, 2 h, 3 h, 4 h, 5 h, 6 h, 8 h, or 10 h, etc., but is not limited to the numerical values listed, and other numerical values not listed within the numerical range are equally applicable.

Preferably, residence time of the raw material solution in step (1) is 0.1-15 h, for example, 0.1 h, 0.5 h, 1 h, 3 h, 5 h, 6 h, 8 h, 10 h, 12 h, or 15 h, etc., but is not limited to the numerical values listed, and other numerical values not listed within the numerical range are equally applicable.

Preferably, in a process of the polymerization reaction in step (1), the low-carbon olefin is continuously introduced to maintain the pressure.

As a preferred technical solution in this application, in a process of the gas-solid-liquid separation in step (2), the low-carbon olefin is discharged for recovery, and replaced with a protective gas, and the protective gas can be selected from nitrogen or an inert gas.

Preferably, the residual material after recovering the low-carbon olefin in step (2) is discharged in a solid-liquid manner.

Preferably, the discharged low-carbon olefin is pressurized and then returned to step (1) for reuse, with the pressurized pressure selected within the above-mentioned reaction pressure range.

As a preferred technical solution in this application, a method of the solid-liquid separation in step (2) includes any one or a combination of at least two of decantation, filtration or centrifugation, and typical but non-limiting examples of the combination include: a combination of decantation and filtration, a combination of filtration and centrifugation, a combination of decantation, filtration and centrifugation, and the like.

Preferably, the filtration includes any one of gravity filtration, vacuum filtration or pressure filtration.

Preferably, the filter used for the filtration includes an atmospheric filter, a vacuum filter or a pressurized filter.

Preferably, the residual material is subjected to the pressure filtration using the protective gas, and an obtained filter cake is washed, dried and then crushed.

Preferably, the washing is performed using the solvent in step (1), and an ether compound may also be used, including any one or a combination of at least two of C1-C10 saturated ether compounds, preferably diethyl ether and/or propyl ether.

Preferably, a temperature of the drying is 30-150° C., for example, 30° C., 40° C., 50° C., 60° C., 70° C., 80° C., 90° C., 100° C., 110° C., or 120° C., etc., but is not limited to the numerical values listed, and other numerical values not listed within the numerical range are equally applicable, preferably 80-120° C.

Preferably, drying time is 1-72 h, for example, 1 h, 6 h, 12 h, 18 h, 24 h, 30 h, 36 h, 42 h, 48 h, 54 h, 60 h, 66 h, or 72 h, etc., but is not limited to the numerical values listed, and other numerical values not listed within the numerical range are equally applicable, preferably 24-72 h.

Preferably, drying pressure is 0.1-101 kPa, for example, 0.1 kPa, 1 kPa, 10 kPa, 20 kPa, 40 kPa, 60 kPa, 80 kPa, or 101 kPa, etc., but is not limited to the numerical values listed, and other numerical values not listed within the numerical range are equally applicable, preferably 1-10 kPa.

Preferably, the olefin functional polymer in step (2) is a microspherical particle with a particle size of 10-50 μm, for example, 10 μm, 15 μm, 20 μm, 25 μm, 30 μm, 35 μm, 40 μm, or 50 μm, etc., but is not limited to the numerical values listed, and other numerical values not listed within the numerical range are equally applicable.

As a preferred technical solution in this application, the liquid-phase material in step (2) is separated, and an obtained recovered solvent is returned to step (1) for reuse.

In this application, the liquid-phase material can also be directly reused without separation, for preparation of the raw material solution or as a washing solvent.

Preferably, a method of separating the liquid phase material in step (3) includes any one or a combination of at least two of distillation, membrane separation, washing, or extraction, and typical but non-limiting examples of the combination include: a combination of distillation and membrane separation, a combination of distillation and extraction, a combination of distillation, membrane separation and washing, and the like, preferably distillation.

Preferably, the recovered solvent is returned to step (1) and/or step (2) for reuse for preparing the raw material solution and/or washing the filter cake.

As a preferred technical solution in this application, the method includes the following steps:
(1) introducing the low-carbon olefin into the reactor, then raising the temperature and pressure, where the low-carbon olefin includes any one or a combination of at least two of ethylene, propylene, butene, or butadiene, and the reactor includes any one of the reaction kettle, the tubular reactor, the microchannel reactor, the fluidized bed reactor, or the boiling bed reactor, adding the raw material solution prepared by the functional monomer, the initiator and the solvent into the reactor in the continuous feeding manner after the reaction temperature and the reaction pressure are reached, where the functional monomer includes any one or a combination of at least two of maleic anhydride, maleimide or maleic acid, the initiator includes the azo compound and/or the peroxide compound, the solvent includes any one or a combination of at least two of the organic alkanoate compound, the alkane compound or the aromatic hydrocarbon compound, the molar ratio of the initiator to the functional monomer is (0.001-0.2):1, the mass ratio of the solvent to the functional monomer is (2-50):1, and pumping the raw material solution into the reactor through being pressurized by the transfer pump to generate the polymerization reaction, where the temperature of the polymerization reaction is 50-150° C., the pressure of the polymerization reaction is 0.1-10 MPa, the feeding time is 0.1-10 h, the residence time is 0.1-15 h, and in the process of the polymerization reaction, the low-carbon olefin is continuously introduced to maintain the pressure;
(2) first performing the gas-solid-liquid separation on the system after the polymerization reaction in step (1), where in the process of the gas-solid-liquid separation, a residual low-carbon olefin is discharged and replaced with the protective gas, pressurizing the discharged low-carbon olefin and then returning it to step (1) for reuse, discharging the residual material in the solid-liquid manner and performing the solid-liquid separation, performing the pressure filtration on the residual material using the protective gas, and washing, drying and then crushing the obtained filter cake to obtain the solid-phase olefin functional polymer and the liquid-phase material, where the olefin functional polymer is the microspherical particle with the particle size of 10-50 km; and
(3) separating the liquid-phase material obtained in step (2), where the method of the separation includes any one or a combination of at least two of distillation, membrane separation, washing, or extraction, and returning the obtained recovered solvent to step (1) and/or step (2) for reuse for preparing the raw material solution and/or washing the filter cake.

Compared with the prior art, this application has the following beneficial effects:
(1) the method in this application adopts a heterogeneous polymerization method, realizes the same-chain alternating copolymerization of the low-carbon gaseous olefin and the liquid functional monomer through the pressure reaction of the two, and can prepare olefin functional polymers with a high functional group content, high reactivity and wide application;
(2) after the polymerization is completed in this application, a relatively stable milky dispersion system can be directly obtained, a post-treatment process is simple, separation and purification are easy, the raw material can be recycled, and the conversion rate of the raw material and the yield of a product are improved;
(3) the method in this application adopts a continuous feeding mode of the raw material solution, can regulate and control the concentration of the monomer and the initiator in the reaction in real time, improves the concentration of the monomer and the utilization rate of the raw material, regulates the molecular weight of the olefin functional polymer, can increase the concentration of the initiator, reduces polymerization pressure, and shortens total process flow time;
(4) the method in this application can achieve complete closure of reaction system equipment, and can prevent impurities in the air from entering the reaction system during a low-carbon olefin circulation process; and
(5) the method in this application is simple to operate, has mild reaction conditions, saves energy consumption, has low costs, and is environmentally friendly.

In a second aspect of this application, this application further provides use of the olefin functional polymer obtained based on the first aspect above, where the use includes use of the olefin functional polymer in preparation of a modified reinforced resin, an adhesive, a scale inhibitor, or a glass fiber impregnating agent. The use of the olefin functional polymer in preparation of the reinforced resin includes the following steps: mixing the olefin functional polymer with a matrix resin and a filler to obtain the modified reinforced resin; the use of the olefin functional polymer in preparation of the modified adhesive includes the following steps: subjecting the olefin functional polymer and an alcohol to an esterification to obtain the adhesive; the use of the olefin functional polymer in preparation of the scale inhibitor includes the following steps: subjecting the olefin functional polymer to an anion cation ionization reaction to obtain the scale inhibitor; and the use of the olefin functional polymer in preparation of the glass fiber impregnating agent includes the following steps: mixing the olefin functional polymer with a coupling agents, a pH regulator and water to obtain the glass fiber impregnating agent.

In this application, for the synthesis of the olefin functional polymer, the selection of an olefin and the functional monomer has a significant impact on the performance of the polymer. The present application selects a low-carbon gaseous olefin to react with a liquid functional monomer, and the difference in the phase state between the two makes it relatively difficult for both the olefin and the functional monomer to be in a liquid form, and a low-carbon gaseous olefin usually does not contain side chains, making the reaction more difficult compared with a liquid olefin. This application increases a monomer concentration and a reaction rate, improves a raw material conversion rate and a product yield, and realizes the alternating copolymerization of a gaseous olefin monomer and a functional monomer in a same chain by a pressure reaction and heterogeneous polymerization; and this application has a simple operation process, mild reaction conditions, easy separation and purification, and recyclable raw materials, saves energy consumption, has low costs, and is environmentally friendly.

At the same time, this application utilizes the characteristics of a high functional group content and high reaction activity in the olefin functional polymer, takes the olefin functional polymer as a reaction platform, and utilizes its derivatization pathway to prepare a variety of modified materials suitable for different fields through chemical reactions such as esterification, hydrolysis and modification, and develops a variety of downstream products, for example, compatible modifiers, adhesives and scale inhibitors, etc., so as to broaden the application range of the olefin functional polymer.

### (A) Use of the Olefin Functional Polymer in Preparation of the Reinforced Resin

As a preferred technical solution in this application, the olefin functional polymer obtained in the first aspect above is mixed with a matrix resin and a filler as a compatible modifier.

Preferably, the matrix resin includes a thermoplastic resin and/or a thermosetting resin.

Preferably, the thermoplastic resin includes any one or a combination of at least two of PC (polycarbonate), PA (polyamide), POM (polyoxymethylene), PBT (polybutylene terephthalate), PET (polyethylene terephthalate), PVC (polyvinyl chloride), PS (polystyrene), PE (polyethylene), or ABS (acrylonitrile-butadiene-styrene), and typical but non-limiting examples of the combination include: a combination of PC and PA, a combination of PA and PET, a combination of PET, PVC and PS, a combination of PC, PBT, PVC and ABS, and the like.

Preferably, the thermosetting resin includes any one or a combination of at least two of EP (epoxy resin), UPR (Unsaturated Polyester Resin), PU (polyurethane), or UF (urea-formaldehyde), and typical but non-limiting examples of the combination include: a combination of EP and UPR, a combination of UPR and PU, a combination of EP, PU and UF, and the like.

Preferably, the filler includes an inorganic filler and/or an organic filler.

Preferably, an addition amount of the matrix resin accounts for 30-90 wt % of a total amount of a mixture, for example, 30 wt %, 40 wt %, 50 wt %, 60 wt %, 70 wt %, 80 wt %, or 90 wt %, etc., but is not limited to the numerical values listed, and other numerical values not listed within the numerical range are equally applicable; an addition amount of the filler accounts for 5-65 wt % of the total amount of the mixture, for example, 5 wt %, 10 wt %, 20 wt %, 30 wt %, 40 wt %, 50 wt %, 60 wt %, or 65 wt %, etc., but is not limited to the numerical values listed, and other numerical values not listed within the numerical range are equally applicable; and an addition amount of the olefin functional polymer accounts for 3-15 wt % of the total amount of the mixture, for example, 3 wt %, 5 wt %, 8 wt %, 10 wt %, 12 wt %, or 15 wt %, etc., but is not limited to the numerical values listed, and other numerical values not listed within the numerical range are equally applicable.

As a preferred technical solution in this application, a method of the mixing includes any one of mechanical blending, solution blending or latex blending.

Preferably, the mechanical blending includes: initially mixing the olefin functional polymers with the matrix resin and the filler, performing internal mixing, and then performing extrusion granulation to prepare the modified reinforced resin.

Preferably, the internal mixing is performed in an internal mixer, and a temperature of the internal mixing is 120-400° C., for example, 120° C., 150° C., 180° C., 200° C., 250° C., 300° C., 350° C., or 400° C., etc., but is not limited to the numerical values listed, and other numerical values not listed within the numerical range are equally applicable.

Preferably, the extrusion granulation is performed using a twin screw extruder or a single screw extruder.

Preferably, the solution blending includes: dissolving the olefin functional polymer, the matrix resin and the filler in a solvent, mixing evenly, and then removing the solvent to obtain the modified reinforced resin.

Preferably, the solvent includes any one or a combination of at least two of an organic alkanoate compound, an alkane compound or an aromatic hydrocarbon compound, and typical but non-limiting examples of the combination include: a combination of an organic alkanoate compound and an alkane compound, a combination of an alkane compound and an aromatic hydrocarbon compound, a combination of an organic alkanoate compound, an alkane compound and an aromatic hydrocarbon compound, and the like.

Preferably, a method of removing the solvent is pressure filtration.

Preferably, the latex blending includes: dissolving the olefin functional polymer, the matrix resin and the filler each in a solvent, then distilling to make latex, uniformly mixing, and coagulating, drying and plasticizing to obtain the modified reinforced resin.

### (B) Use of the Olefin Functional Polymers in Preparation of the Adhesive

As a preferred technical solution in this application, the alcohol includes any one or a combination of at least two of methanol, ethanol, propanol, or butanol, and typical but non-limiting examples of the combination include a combination of methanol and ethanol, a combination of ethanol and butanol, a combination of methanol, ethanol and butanol, and the like.

Preferably, a molar ratio of the anhydride to the alcohol in the olefin functional polymer is 1:(2-5), for example, 1:2, 1:2.5, 1:3, 1:3.5, 1:4, 1:4.5, or 1:5, etc., but is not limited to the numerical values listed, and other numerical values not listed within the numerical range are equally applicable.

Preferably, a temperature of the esterification reaction is 60-80° C., for example, 60° C., 65° C., 70° C., 75° C., or 80° C., etc., but is not limited to the numerical values listed, and other numerical values not listed within the numerical range are equally applicable.

Preferably, time of the esterification reaction is 3-5 h, for example, 3 h, 3.5 h, 4 h, 4.5 h, or 5 h, etc., but is not limited to the numerical values listed, and other numerical values not listed within the numerical range are equally applicable.

Preferably, after the esterification reaction, an esterification product is obtained by concentration and drying.

As a preferred technical solution in this application, before the anion cation ionization reaction, an esterification reaction between the olefin functional polymer and an alcohol is further included to generate a monoesterified olefin functional polymer.

Preferably, the alcohol includes any one or a combination of at least two of methanol, ethanol, butanol, ethylene glycol, or propylene glycol, and typical but non-limiting examples of the combination include: a combination of methanol and ethanol, a combination of ethanol and ethylene glycol, a combination of methanol, ethanol and butanol, a combination of ethanol, ethylene glycol and propylene glycol, and the like.

Preferably, a molar ratio of the anhydride to the alcohol in the olefin functional polymer is 1:(1-10), for example, 1:1, 1:2, 1:3, 1:4, 1:5, 1:6, 1:8, or 1:10, etc., but is not limited to the numerical values listed, and other numerical values not listed within the numerical range are equally applicable.

Preferably, a temperature of the esterification reaction is 50-80° C., for example, 50° C., 55° C., 60° C., 65° C., 70° C., 75° C., or 80° C., etc., but is not limited to the numerical values listed, and other numerical values not listed within the numerical range are equally applicable.

Preferably, pressure of the esterification reaction is 0-0.5 MPa, for example, 0 MPa, 0.1 MPa, 0.2 MPa, 0.3 MPa, 0.4 MPa, or 0.5 MPa, etc., but is not limited to the numerical values listed, and other numerical values not listed within the numerical range are equally applicable.

Preferably, time of the esterification reaction is 0.5-24 h, for example, 0.5 h, 1 h, 2 h, 4 h, 6 h, 8 h, 12 h, 16 h, 20 h, or 24 h, etc., but is not limited to the numerical values listed, and other numerical values not listed within the numerical range are equally applicable.

### (C) Use of the Olefin Functional Polymer in Preparation of the Scale Inhibitor

Preferably, the anion cation ionization reaction includes a reaction between the olefin functional polymer or monoesterified olefin functional polymer and a quaternary ammonium salt, a base or an acid.

Preferably, the quaternary ammonium salt includes any one or a combination of at least two of epoxypropyltrimethylammonium chloride, octadecyldimethylammonium chloride, an octadecylamine polyoxyethylene ether diquaternary ammonium salt, or an didodecylamine polyoxyethylene ether monoquaternary ammonium salt, and typical but non-limiting examples of the combination include: a combination of epoxypropyltrimethylammonium chloride and octadecyldimethylammonium chloride, a combination of octadecyldimethylammonium chloride and octadecylamine polyoxyethylene ether diquaternary ammonium salt, a combination of epoxypropyltrimethylammonium chloride, octadecyldimethylammonium chloride and didodecylamine polyoxyethylene ether monoquaternary ammonium salt, and the like.

Preferably, the base includes a caustic alkali, added in a form of an alkaline solution.

Preferably, when the quaternary ammonium salt is used, an alkaline solution is added simultaneously.

Preferably, the acid includes any one or a combination of at least two of sulfuric acid, persulfuric acid or phosphorus pentoxide, typical but non-limiting examples of the combination include: a combination of sulfuric acid and persulfuric acid, a combination of persulfuric acid and phosphorus pentoxide, a combination of sulfuric acid, persulfuric acid and phosphorus pentoxide, and the like.

Preferably, the anion cation ionization reaction includes any one or a combination of at least two of an reaction between the monoesterified olefin functional polymer and the quaternary ammonium salt in an alkaline solution to prepare a cationic polymer scale inhibitor, an reaction between the olefin functional polymer and the quaternary ammonium salt in the alkaline solution to prepare a cationic polymer scale inhibitor, a saponification reaction between the olefin functional polymer and the alkaline solution to prepare a carboxylate type anionic polymer scale inhibitor, a reaction between a diol monoesterified olefin functional polymer and sulfuric acid to prepare a sulfate type anionic polymer scale inhibitor, or a reaction between the diol monoesterified olefin functional polymer and phosphorus pentoxide to prepare a phosphate type anionic polymer scale inhibitor.

### (D) Use of the Olefin Functional Polymer in Preparation of the Glass Fiber Impregnating Agent

As a preferred technical solution in this application, the coupling agent includes any one or a combination of at least two of a silane coupling agent, an aluminate coupling agent or a titanate coupling agent, and typical but non-limiting examples of the combination include: a combination of a silane coupling agent and an aluminate coupling agent, a combination of a silane coupling agent and a titanate coupling agent, a combination of a silane coupling agent, an aluminate coupling agent and a titanate coupling agent, and the like.

In this application, the most widely used coupling agent among the above-mentioned coupling agents is a silane coupling agent, and selectable types include A-151 (vinyl triethoxysilane), KH550 (γ-aminopropyltriethoxysilane), KH570 (γ-methacryloxypropyltrimethoxysilane), etc. Currently, new types of silane coupling agents are also used, for example, organic silicon peroxide coupling agents.

Preferably, the pH regulator includes an acid regulator or a base regulator.

Preferably, the acid regulator includes any one or a combination of at least two of acetic acid, citric acid, formic acid, or oxalic acid, and typical but non-limiting examples of the combination include: a combination of formic acid and acetic acid, a combination of citric acid and oxalic acid, a combination of acetic acid, citric acid and formic acid, and the like.

Preferably, the base regulator includes any one or a combination of at least two of aqueous ammonia, sodium hydroxide, sodium bicarbonate, a basic amino acid or an organic amine, and typical but non-limiting examples of the combination include: a combination of aqueous ammonia and sodium hydroxide, a combination of sodium hydroxide and sodium bicarbonate, a combination of aqueous ammonia and an organic amine, a combination of sodium bicarbonate, a basic amino acid and an organic amine, and the like.

Preferably, preparation steps of the glass fiber impregnating agent include: first adding the coupling agent to water for stirring, then adding a solid-phase olefin functional polymer, stirring evenly, and then adding the pH regulator to obtain the glass fiber impregnating agent.

Preferably, stirring time after adding the coupling agent is 20-30 min, for example, 20 min, 22 min, 25 min, 27 min, or 30 min, etc., but is not limited to the numerical values listed, and other numerical values not listed within the numerical range are equally applicable.

Preferably, stirring time after adding the olefin functional polymer is 60-240 min, for example, 60 min, 90 min, 120 min, 150 min, 180 min, 210 min, or 240 min, etc., but is not limited to the numerical values listed, and other numerical values not listed within the numerical range are equally applicable; and a stirring rate is 100-800 rpm, for example, 100 rpm, 200 rpm, 300 rpm, 400 rpm, 500 rpm, 600 rpm, 700 rpm, or 800 rpm, etc., but is not limited to the numerical values listed, and other numerical values not listed within the numerical range are equally applicable.

Preferably, a pH value after adding the pH regulator is adjusted to 6-10, for example, 6, 7, 8, 9, or 10, etc., but is not limited to the numerical values listed, and other numerical values not listed within the numerical range are equally applicable.

Preferably, a mass proportion of water in the glass fiber impregnating agent is 20-95 wt %, for example, 20 wt %, 30 wt %, 40 wt %, 50 wt %, 60 wt %, 70 wt %, 80 wt %, 90 wt %, or 95 wt %, etc., but is not limited to the numerical values listed, and other numerical values not listed within the numerical range are equally applicable, while a remaining portion is a solid-phase component.

As a preferred technical solution in this application, the glass fiber impregnating agent in step (3) further includes any one or a combination of at least two of a lubricant, a defoamer or an antioxidant, and typical but non-limiting examples of the combination include a combination of a lubricant and a defoamer, a combination of a defoamer and an antioxidant, a combination of a lubricant, a defoamer and an antioxidant, and the like.

Preferably, the lubricant includes any one or a combination of at least two of stearicamide, oleamide, palmiticamide, stearic acid, methyl stearate, butyl stearate, polyethylene wax, or polypropylene wax, and typical but non-limiting examples of the combination include: a combination of stearicamide and oleamide, a combination of stearic acid and methyl stearate, a combination of polyethylene wax and polypropylene wax, a combination of oleamide, palmiticamide and stearic acid, and the like.

Preferably, the defoamer includes any one or a combination of at least two of a high carbon alcohol fatty acid ester complex, a polyoxyethylene polyoxypropylene pentaerythritol ether, a polyoxyethylene polyoxypropylene amine ether, a polyoxypropylene glycerol ether, or polyoxypropylene, and the typical but non-limiting examples of the combination include: a combination of a high carbon alcohol fatty acid ester complex and a polyoxyethylene polyoxypropylene pentaerythritol ether, a combination of a polyoxyethylene polyoxypropylene pentaerythritol ether and a polyoxypropylene glycerol ether, a combination of a polyoxyethylene polyoxypropylene pentaerythritol ether, a polyoxyethylene polyoxypropylene amine ether and a polyoxypropylene glycerol ether, and the like.

Preferably, the antioxidant includes a hindered phenolic antioxidant and/or a phosphite antioxidant.

Preferably, the antioxidant includes any one or a combination of at least two of antioxidant 1010 (tetrakis[μ-(3.5-di-tert-butyl, 4-hydroxyphenyl) propionate]pentaerythritol), antioxidant 1076 (β-(3.5-di-tert-butyl, 4-hydroxyphenyl) octadecyl propionate), antioxidant 3114 (1,3,5-tris(3,5-di-tert-butyl-4-hydroxybenzyl) isocyanuric acid), antioxidant 168 (tris(2.4-di-tert-butylphenyl)phosphite), or antioxidant 626 (bis(2,4-di-tert-butylphenyl) pentaerythritol diphosphate), and the typical but non-limiting examples of the combination include: a combination of antioxidant 1010 and antioxidant 1076, a combination of antioxidant 168 and antioxidant 626, antioxidant 3114 and antioxidant 168, and the like.

Preferably, timing for adding the lubricant, defoamer, and antioxidant in preparation of the glass fiber impregnating agent is: to be added together with the olefin functional polymer.

In this application, when the olefin functional polymer is used to prepare the glass fiber impregnating agent, the olefin functional polymer used can also be added with a comonomer during synthesis, resulting in a polyolefin functional polymer at this time that can effectively regulate an anhydride value of the olefin functional polymer, where types of the comonomer include any one or a combination of at least two of methyl acrylate, methyl methacrylate, vinyl acetate, N,N-dimethylacrylamide, acrylamide, or acrylonitrile, and typical but non-limiting examples of the combination include: a combination of methyl acrylate and methyl methacrylate, a combination of methyl acrylate and vinyl acetate, a combination of N,N-dimethylacrylamide, acrylamide and acrylonitrile, a combination of methyl methacrylate, vinyl acetate and acrylamide, and the like.

As a preferred technical solution in this application, the use includes the following steps:
(1) introducing a low-carbon olefin into a reactor, then raising temperature and pressure, where the low-carbon olefin includes any one or a combination of at least two of ethylene, propylene, butene, or butadiene, and the reactor includes any one of a tank reactor, a tubular reactor, a microchannel reactor, a tower reactor, a fluidized bed reactor, or a boiling bed reactor, adding a raw material solution prepared by a functional monomer, an initiator and a solvent into the reactor after reaction temperature and reaction pressure are reached, where the functional monomer includes any one or a combination of at least two of maleic anhydride, maleimide or maleic acid, the initiator includes an azo compound and/or a peroxide compound, the solvent includes any one or a combination of at least two of an organic alkanoate compound, an alkane compound or an aromatic hydrocarbon compound, a molar ratio of the initiator to the functional monomer is (0.001-0.2):1, a mass ratio of the solvent to the functional monomer is (2-50):1, and pumping the raw material solution into the reactor at a constant speed after being pressurized by a transfer pump to generate a polymerization reaction, where a temperature of the polymerization reaction is 50-150° C., pressure of the polymerization reaction is 0.1-10 MPa, residence time is 10 s-10 h, and in a process of the polymerization reaction, the low-carbon olefin is continuously introduced to maintain the pressure;
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing solid-liquid separation, performing pressure filtration using a protective gas, and drying an obtained filter cake to obtain a solid-phase olefin functional polymer and a liquid-phase material, where the olefin functional polymer is a microspherical particle with a particle size of 10-50 km; separating the liquid-phase material, where a method of the separation includes any one or a combination of at least two of distillation, membrane separation, washing, or extraction, returning a separated recovered solvent to step (1) and/or step (2) for reuse, and preparing the raw material solution and/or washing the filter cake;
(3) mixing the olefin functional polymer obtained in step (2) with a matrix resin and a filler as a compatible modifier to obtain a modified reinforced resin, where the matrix resin includes a thermoplastic resin and/or a thermosetting resin, the filler includes an inorganic filler and/or an organic filler, an addition amount of the matrix resin accounts for 30-90 wt % of a total amount of a mixture, an addition amount of the filler accounts for 5-65 wt % of the total amount of the mixture, and an addition amount of the olefin functional polymer accounts for 3-15 wt % of the total amount of the mixture, a method of the mixing includes any one of mechanical blending, solution blending or latex blending;
subjecting the olefin functional polymer obtained in step (2) and an alcohol to an esterification reaction, where the alcohol includes any one or a combination of at least two of methanol, ethanol, propanol, or butanol, a molar ratio of an anhydride in the olefin functional polymer to the alcohol is 1:(2-5), a temperature of the esterification reaction is 60-80° C., and time of the esterification reaction is 3-5 h, and then performing concentration and drying to obtain an adhesive;
subjecting the olefin functional polymer obtained in step (2) to an anion cation ionization reaction to obtain a scale inhibitor, where before the anion cation ionization reaction, an esterification reaction between the olefin functional polymer and the alcohol is further included to generate a monoesterified olefin functional polymer, the alcohol includes any one or a combination of at least two of methanol, ethanol, butanol, ethylene glycol, or propylene glycol; the anion cation ionization reaction includes a reaction between the olefin functional polymer or monoesterified olefin functional polymer and a quaternary ammonium salt, a base or an acid, the quaternary ammonium salt includes any one or a combination of at least two of epoxypropyltrimethylammonium chloride, octadecyldimethylammonium chloride, an octadecylamine polyoxyethylene ether diquaternary ammonium salt, or an didodecylamine polyoxyethylene ether monoquaternary ammonium salt; and the anion cation ionization reaction includes any one or a combination of at least two of an reaction between the monoesterified olefin functional polymer and the quaternary ammonium salt in an alkaline solution to prepare a cationic polymer scale inhibitor, an reaction between the olefin functional polymer and the quaternary ammonium salt in the alkaline solution to prepare a cationic polymer scale inhibitor, a saponification reaction between the olefin functional polymer and the alkaline solution to prepare a carboxylate type anionic polymer scale inhibitor, a reaction between a diol monoesterified olefin functional polymer and sulfuric acid to prepare a sulfate type anionic polymer scale inhibitor, or a reaction between the diol monoesterified olefin functional polymer and phosphorus pentoxide to prepare a phosphate type anionic polymer scale inhibitor;
or mixing the olefin functional polymer obtained in step (2) with a coupling agent, a pH regulator and water, specifically including: first adding the coupling agent to water and stirring for 20-30 min, then adding a lubricant, the olefin functional polymer, a defoamer, and an antioxidant and stirring for 60-240 min at a stirring rate of 100-800 rpm, and then adding the pH regulator with a pH value adjusted to 6-10 to obtain a glass fiber impregnating agent.

Compared with the prior art, this application has the following beneficial effects:
(1) this application can obtain an olefin functional polymer with a low-carbon gaseous olefin and a functional monomer alternately copolymerized in a same chain, with a controllable molecular weight, a high functional group content, high reactive activity, and wide applications through a pressure reaction between a low-carbon gaseous olefin and a liquid functional monomer, using a heterogeneous polymerization method, and preparing a continuous feed process for a raw material solution;
(2) this application has a simple operation process, mild reaction conditions, easy separation and purification, and recyclable raw materials, saves energy consumption, and has low costs and high economic benefits; and
(3) this application utilizes the characteristics of a high functional group content and high reaction activity in the olefin functional polymer, and takes the olefin functional polymer as a reaction platform to prepare a variety of modified materials suitable for different fields through chemical reactions such as esterification, hydrolysis and modification, and develops a variety of downstream products, so as to broaden the application range of the olefin functional polymer.

### BRIEF DESCRIPTION OF THE DRAWINGS

FIG. 1 is a process flow diagram of a method of synthesizing an olefin functional polymer in a continuous feeding manner provided in Example 1 of this application.

### DETAILED DESCRIPTION OF THE EMBODIMENTS

To better illustrate this application and facilitate understanding of the technical solutions of this application, the following is a further detailed explanation of this application. However, the following examples are only simple examples of this application and do not represent or limit the scope of protection of the rights in this application, and the scope of protection in this application is subject to the claims.

### 1. a Method of Synthesizing an Olefin Functional Polymer in a Continuous Feeding Manner

The detailed description of the embodiments section in this application provides a method of synthesizing an olefin functional polymer in a continuous feeding manner, including the following steps:
(1) introducing a low-carbon olefin into a reactor, then raising temperature and pressure, and adding a raw material solution prepared by a functional monomer, an initiator and a solvent into the reactor after reaction temperature and reaction pressure are reached to generate a polymerization reaction; and
(2) first performing gas-solid-liquid separation on a system after the polymerization reaction in step (1), recovering a low-carbon olefin, returning a discharged low-carbon olefin to step (1) for reuse, and performing solid-liquid separation on a residual material after discharge to obtain a solid-phase olefin functional polymer and a liquid-phase material.

The following are typical but non-limiting examples of this application:

### Example I-1

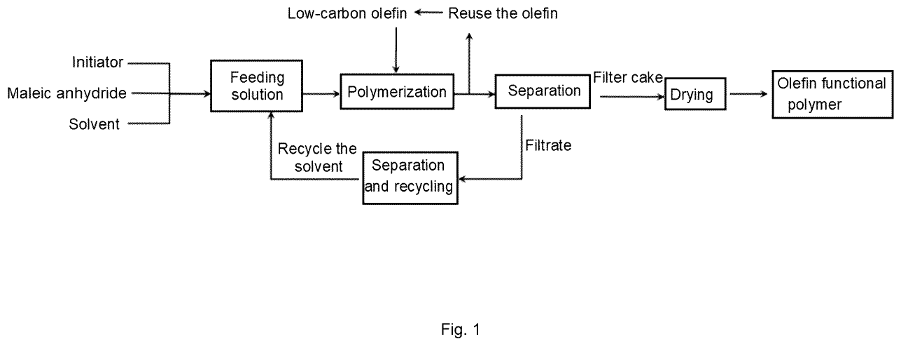

This example provided a method of synthesizing an olefin functional polymer in a continuous feeding manner, where the process flow diagram of the method is shown in FIG. 1, including the following steps:
(1) introducing a low-carbon olefin into a microchannel reactor, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the reactor in the continuous feeding manner after reaching reaction temperature and reaction pressure, where the functional monomer was maleic anhydride, the initiator was dibenzoyl peroxide, the solvent was isoamyl acetate, a molar ratio of the initiator to the functional monomer was 0.01:1, and a mass ratio of the solvent to the functional monomer was 5:1, and pumping the raw material solution after being preheated into the reactor through a transfer pump to generate a polymerization reaction, where temperature of the polymerization reaction was 100° C., pressure of the polymerization reaction was 6 MPa, feeding time was 0.1 h, total residence time was 0.1 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing pressure filtration under nitrogen on a residual material by a three-in-one filter, and an obtained filter cake was washed, drided and then crushed to obtain a solid-phase olefin functional polymer and a liquid-phase material, where a solvent used for the washing was n-hexane, temperature of the drying was 30° C., time was 10 h, pressure was 101 kPa, and the olefin functional polymer was a microspherical particle; and (3) performing rectification separation on the liquid-phase material obtained in step (2), and returning a rectified fraction at a column top as a recovered solvent for each component to steps (1) and (2) each for reuse in preparing the raw material solution and washing the filter cake.

### Example I-2

This example provided a method of synthesizing an olefin functional polymer in a continuous feeding manner, as shown, including the following steps:
(1) introducing a low-carbon olefin into a reaction kettle, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the reaction kettle in the continuous feeding manner after reaching reaction temperature and reaction pressure, where the functional monomer was maleic anhydride, the initiator was azodiisobutyronitrile, the solvent was ethyl acetate and butyl acetate with a volume ratio of 1:1, a molar ratio of the initiator to the functional monomer was 0.1:1, and a mass ratio of the solvent to the functional monomer was 20:1, and pumping the raw material solution after being preheated into the reaction kettle through a transfer pump to generate a polymerization reaction, where temperature of the polymerization reaction was 70° C., pressure of the polymerization reaction was 4 MPa, feeding time was 8 h, total residence time was 10 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing pressure filtration under nitrogen on a residual material by a three-in-one filter, an obtained filter cake was washed, dried and then crushed to obtain a solid-phase olefin functional polymer and a liquid-phase material, where a solvent used for the washing was butyl acetate, temperature of the drying was 120° C., time was 48 h, pressure was 50 kPa, and the olefin functional polymer was a microspherical particle; and
(3) performing rectification separation on the liquid-phase material obtained in step (2), and returning a rectified fraction at a column top as a recovered solvent for each component to steps (1) and (2) each for reuse in preparing the raw material solution and washing the filter cake.

### Example I-3

This example provided a method of synthesizing an olefin functional polymer in a continuous feeding manner, including the following steps:
(1) introducing a low-carbon olefin into a reaction kettle, then raising the temperature and pressure, where the low-carbon olefin was isobutene, and nitrogen was used to replace air before the low-carbon olefin was introduced into the microchannel reactor, pumping a raw material solution prepared by a functional monomer, an initiator and a solvent into the reaction kettle in the continuous feeding manner after reaching reaction temperature and reaction pressure, where the functional monomer was maleic anhydride, the initiator was azobisisoheptonitrile, the solvent was ethyl acetate, a molar ratio of the initiator to the functional monomer was 0.06:1, and a mass ratio of the solvent to the functional monomer was 8:1, and pumping the raw material solution after being preheated into the reaction kettle through a transfer pump to generate a polymerization reaction, where temperature of the polymerization reaction was 90° C., pressure of the polymerization reaction was 3.5 MPa, feeding time was 5 h, total residence time was 7 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing pressure filtration under nitrogen on a residual material by a three-in-one filter, and an obtained filter cake was washed, dried and then crushed to obtain a solid-phase olefin functional polymer and a liquid-phase material, where a solvent used for the washing was ethyl acetate, temperature of the drying was 60° C., time was 24 h, pressure was 20 kPa, and the olefin functional polymer was a microspherical particle; and
(3) performing distillation separation on the liquid-phase material obtained in step (2), and returning a distilled fraction at a column top as a recovered solvent to step (1) for reuse in preparing the raw material solution.

### Example I-4

This example provided a method of synthesizing an olefin functional polymer in a continuous feeding manner, including the following steps:
(1) introducing a low-carbon olefin into a fluidized bed reactor, then raising the temperature and pressure, where the low-carbon olefin was propylene, and nitrogen was used to replace air before the low-carbon olefin was introduced into the microchannel reactor, pumping a raw material solution prepared by a functional monomer, an initiator and a solvent into the fluidized bed reactor in the continuous feeding manner after reaching reaction temperature and reaction pressure, where the functional monomer was maleimide, the initiator was diisopropylbenzene peroxide, the solvent was benzene and xylene in a volume ratio of 1:1, a molar ratio of the initiator to the functional monomer was 0.006:1, and a mass ratio of the solvent to the functional monomer was 10:1, and pumping the raw material solution after being preheated into the reactor through a transfer pump to generate a polymerization reaction, where temperature of the polymerization reaction was 120° C., pressure of the polymerization reaction was 10 MPa, feeding time was 4 h, total residence time was 6 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing pressure filtration under argon on a residual material by a three-in-one filter, and an obtained filter cake was washed, dried and then crushed to obtain a solid-phase olefin functional polymer and a liquid-phase material, where a solvent used for the washing was cyclohexane, temperature of the drying was 110° C., time was 24 h, pressure was 1 kPa, and the olefin functional polymer was a microspherical particle; and
(3) performing rectification separation on the liquid-phase material obtained in step (2), and returning a rectified fraction at a column top as a recovered solvent for each component to steps (1) and (2) each for reuse in preparing the raw material solution and washing the filter cake.

### Example I-5

This example provided a method of synthesizing an olefin functional polymer in a continuous feeding manner, including the following steps:
(1) introducing a low-carbon olefin into a tubular reactor, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the tubular reactor after reaching reaction temperature and reaction pressure, where the functional monomer was maleic acid, the initiator was azodiisobutyronitrile and dodecanoyl peroxide in a molar ratio of 1:1, the solvent was xylene, a molar ratio of the initiator to the functional monomer was 0.2:1, and a mass ratio of the solvent to the functional monomer was 40:1, and pumping the raw material solution after being preheated into the tubular reactor through a transfer pump to generate a polymerization reaction, where temperature of the polymerization reaction was 50° C., pressure of the polymerization reaction was 3 MPa, feeding time was 10 h, total residence time was 15 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing filtering separation on a residual material by an atmospheric filter, and an obtained filter cake was washed, dried and then crushed to obtain a solid-phase olefin functional polymer and a liquid-phase material, where a solvent used for the washing was xylene, temperature of the drying was 120° C., time was 12 h, pressure was 10 kPa, and the olefin functional polymer was a microspherical particle; and
(3) performing distillation separation on the liquid-phase material obtained in step (2), and returning a distilled fraction at a column top as a recovered solvent to steps (1) and (2) for reuse in preparing the raw material solution and washing the filter cake.

### Example I-6

This example provided a method of synthesizing an olefin functional polymer in a continuous feeding manner, including the following steps: (1) introducing a low-carbon olefin into a reaction kettle, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the reaction kettle after reaching reaction temperature and reaction pressure, where the functional monomer was maleic anhydride, the initiator was dimethyl azodiisobutyrate, the solvent was butyl acetate and ethyl acetate in a volume ratio of 5:1, a molar ratio of the initiator to the functional monomer was 0.008:1, and a mass ratio of the solvent to the functional monomer was 10:1, and pumping the raw material solution after being preheated into the reaction kettle through a transfer pump to generate a polymerization reaction, where temperature of the polymerization reaction was 110° C., pressure of the polymerization reaction was 6 MPa, feeding time was 3 h, total residence time was 5 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing filtering separation on a residual material by an atmospheric filter, and an obtained filter cake was washed, dried and then crushed to obtain a solid-phase olefin functional polymer and a liquid-phase material, where a solvent used for the washing was propyl ether, temperature of the drying was 50° C., time was 36 h, pressure was 70 kPa, and the olefin functional polymer was a microspherical particle; and
(3) performing rectification separation on the liquid-phase material obtained in step (2), and returning a rectified fraction at a column top as a recovered solvent for each component to steps (1) and (2) each for reuse in preparing the raw material solution and washing the filter cake.

### Example I-7

This example provided a method of synthesizing an olefin functional polymer in a continuous feeding manner, including the following steps:
(1) introducing a low-carbon olefin into a reaction kettle, then raising the temperature and pressure, where the low-carbon olefin was propylene, and nitrogen was used to replace air before the low-carbon olefin was introduced into the microchannel reactor, pumping a raw material solution prepared by a functional monomer, an initiator and a solvent into the reaction kettle in the continuous feeding manner after reaching reaction temperature and reaction pressure, where the functional monomer was maleic anhydride, the initiator was azodicyclohexylformonitrile, the solvent was n-octane, a molar ratio of the initiator to the functional monomer was 0.15:1, and a mass ratio of the solvent to the functional monomer was 30:1, and pumping the raw material solution after being preheated into the reaction kettle through a transfer pump to generate a polymerization reaction, where temperature of the polymerization reaction was 60° C., pressure of the polymerization reaction was 3.5 MPa, feeding time was 7 h, total residence time was 10 h, and in a process of the polymerization reaction, the low-carbon olefin was continuously introduced to maintain the pressure; and
the operations of steps (2) and (3) referred to Example 4.

According to the tests of raw material monomers and olefin functional polymers in Examples I-1 to I-7 above, the conversion rate of the functional monomers, and the yield and anhydride value of the olefin functional polymers were calculated, and the particle size and weight average molecular weight of the polymers were tested and calculated. The results are shown in Table 1.

TABLE 1
Result data of polymerization reactions in Examples I-1 to I-7

| | Functional | | | | | Weight |
|---|---|---|---|---|---|---|
| | monomer | | | | | average |
| | conversion | Polymer | Anhydride | | | molecular |
| Example | rate/% | yield/% | value/% | D50/μm | D90/μm | weight |
| Example | 98.1 | 94.5 | 76.5 | 22 | 38 | 62000 |
| I-1 | | | | | | |
| Example | 99.7 | 95.9 | 77.2 | 19 | 39 | 61100 |
| I-2 | | | | | | |
| Example | 99.5 | 94.3 | 63.5 | 15 | 38 | 61300 |
| I-3 | | | | | | |
| Example | 99.4 | 94.9 | 72.9 | 14 | 36 | 63900 |
| I-4 | | | | | | |
| Example | 98.7 | 93.1 | 73.3 | 12 | 40 | 61400 |
| I-5 | | | | | | |
| Example | 99.1 | 95.3 | 72.6 | 18 | 39 | 62100 |
| I-6 | | | | | | |
| Example | 98.9 | 94.7 | 69.2 | 18 | 38 | 84200 |
| I-7 | | | | | | |

As can be seen from Table 1, using the method in this application to synthesize the olefin functional polymers, by adjusting polymerization process parameters such as temperature, pressure, feeding ratio, time, solvent mass ratio, etc., the conversion rate of the functional monomers can reach over 98%, and the yield of the polymers can also reach over 93%, the anhydride value of the polymers was over 63.5%, the average particle size of the polymers was in a range of 12-22 μm, the particle size range of the polymers was around 10-50 μm, and the weight average molecular weight of the polymers can be controlled at around 60,000. In the polymerization process, the higher the temperature, the faster the decomposition of the initiators, the lower concentration of mono-radicals and initiator radicals in the system, the lower the polymerization degrees, and the lower the product molecular weights; and in the polymerization process, the higher the pressure, the higher the concentration of the monomer free radicals, and the higher the product molecular weights. Meanwhile, parameters such as initiator feeding ratio, solvent feeding amount, and feeding time had a significant influence on the polymerization effect.

By using the method in this application, the synthesis of olefin functional polymers with different molecular weights can also be achieved by adjusting process parameters such as temperature, pressure, raw material solution ratio, and feeding speed. The following are typical but non-limiting supplementary examples of the synthesis of olefin functional polymers with different molecular weights in this application:

### Example I-8

This example provided a method of synthesizing an olefin functional polymer in a continuous feeding manner, including the following steps:
(1) introducing a low-carbon olefin into a tubular reactor, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the tubular reactor in the continuous feeding manner after reaching reaction temperature and reaction pressure, where the functional monomer was maleic anhydride, the initiator was azodiisobutyronitrile, the solvent was isoamyl acetate, a molar ratio of the initiator to the functional monomer was 0.02:1, and a mass ratio of the solvent to the functional monomer was 20:1, and pumping the raw material solution after being preheated into the reactor through a transfer pump to generate a polymerization reaction, where temperature of the polymerization reaction was 150° C., pressure of the polymerization reaction was 1 MPa, feeding time was 4 h, total residence time was 6 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing filtering separation on a residual material by an atmospheric filter, and an obtained filter cake was washed, dried and then crushed to obtain a solid-phase olefin functional polymer and a liquid-phase material, where a solvent used for the washing was n-hexane, temperature of the drying was 30° C., time was 16 h, pressure was 30 kPa, and the olefin functional polymer was a microspherical particle; and
(3) performing rectification separation on the liquid-phase material obtained in step (2), and returning a rectified fraction at a column top as a recovered solvent for each component to steps (1) and (2) each for reuse in preparing the raw material solution and washing the filter cake.

### Example I-9

This example provided a method of synthesizing an olefin functional polymer in a continuous feeding manner, including the following steps:
(1) introducing a low-carbon olefin into a tubular reactor, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the tubular reactor in the continuous feeding manner after reaching reaction temperature and reaction pressure, where the functional monomer was maleic anhydride, the initiator was azodiisobutyronitrile, the solvent was isoamyl acetate, a molar ratio of the initiator to the functional monomer was 0.01:1, and a mass ratio of the solvent to the functional monomer was 10:1, and pumping the raw material solution after being preheated into the reactor through a transfer pump to generate a polymerization reaction, where temperature of the polymerization reaction was 120° C., pressure of the polymerization reaction was 3 MPa, feeding time was 5 h, total residence time was 8 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing filtering separation on a residual material by an atmospheric filter, and an obtained filter cake was washed, dried and then crushed to obtain a solid-phase olefin functional polymer and a liquid-phase material, where a solvent used for the washing was isoamyl acetate, temperature of the drying was 140° C., time was 36 h, pressure was 60 kPa, and the olefin functional polymer was a microspherical particle; and
(3) performing distillation separation on the liquid-phase material obtained in step (2), and returning a distilled fraction at a column top as a recovered solvent to steps (1) and (2) for reuse in preparing the raw material solution and washing the filter cake.

### Example I-10

This example provided a method of synthesizing an olefin functional polymer in a continuous feeding manner, including the following steps:
(1) introducing a low-carbon olefin into a tubular reactor, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the tubular reactor in the continuous feeding manner after reaching reaction temperature and reaction pressure, where the functional monomer was maleic anhydride, the initiator was azodiisobutyronitrile, the solvent was isoamyl acetate, a molar ratio of the initiator to the functional monomer was 0.008:1, and a mass ratio of the solvent to the functional monomer was 3:1, and pumping the raw material solution after being preheated into the reactor through a transfer pump to generate a polymerization reaction, where temperature of the polymerization reaction was 80° C., pressure of the polymerization reaction was 6 MPa, feeding time was 6 h, total residence time was 8 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing filtering separation on a residual material by an atmospheric filter, and an obtained filter cake was washed, dried and then crushed to obtain a solid-phase olefin functional polymer and a liquid-phase material, where a solvent used for the washing was xylene, temperature of the drying was 100° C., time was 60 h, pressure was 101 kPa, and the olefin functional polymer was a microspherical particle; and
(3) performing rectification separation on the liquid-phase material obtained in step (2), and returning a rectified fraction at a column top as a recovered solvent for each component to steps (1) and (2) each for reuse in preparing the raw material solution and washing the filter cake.

### Example I-11

This example provided a method of synthesizing an olefin functional polymer in a continuous feeding manner, including the following steps:
(1) introducing a low-carbon olefin into a tubular reactor, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the tubular reactor in the continuous feeding manner after reaching reaction temperature and reaction pressure, where the functional monomer was maleic anhydride, the initiator was azodiisobutyronitrile, the solvent was isoamyl acetate, a molar ratio of the initiator to the functional monomer was 0.01:1, and a mass ratio of the solvent to the functional monomer was 5:1, and pumping the raw material solution after being preheated into the reactor through a transfer pump to generate a polymerization reaction, where temperature of the polymerization reaction was 70° C., pressure of the polymerization reaction was 4.5 MPa, feeding time was 8 h, total residence time was 10 h, and in a process of the polymerization reaction, the low-carbon olefin was continuously introduced to maintain the pressure;
(2) first performing gas-solid-liquid separation on a system after the polymerization reaction in step (1), simultaneously recovering a low-carbon olefin, returning a discharged low-carbon olefin after being pressurized to step (1) for reuse, performing filtering separation on a residual material by an atmospheric filter, and an obtained filter cake was washed, dried and then crushed to obtain a solid-phase olefin functional polymer and a liquid-phase material, where a solvent used for the washing was diethyl ether, temperature of the drying was 30° C., time was 8 h, pressure was 80 kPa, and the olefin functional polymer was a microspherical particle; and
(3) performing rectification separation on the liquid-phase material obtained in step (2), and returning a rectified fraction at a column top as a recovered solvent for each component to steps (1) and (2) each for reuse in preparing the raw material solution and washing the filter cake.

According to the tests of raw material monomers and olefin functional polymers in Examples I-8 to I-11 above, the conversion rate of the functional monomers, and the yield and anhydride value of the olefin functional polymers were calculated, and the particle size and weight average molecular weight of the polymers were tested and calculated. The results are shown in Table 2.

TABLE 2
Result data of polymerization reactions in Examples I-8 to I-11

| | Functional | | | | | Weight |
|---|---|---|---|---|---|---|
| | monomer | | | | | average |
| | conversion | Polymer | Anhydride | | | molecular |
| Example | rate/% | yield/% | value/% | D50/μm | D90/μm | weight |
| Example | 99.8 | 96.53 | 73.6 | 12 | 31 | 10700 |
| I-8 | | | | | | |
| Example | 99.7 | 97.20 | 75.8 | 15 | 37 | 41100 |
| I-9 | | | | | | |
| Example | 99.5 | 98.28 | 74.8 | 18 | 39 | 102000 |
| I-10 | | | | | | |
| Example | 99.6 | 97.08 | 76.0 | 20 | 40 | 155000 |
| I-11 | | | | | | |

As can be seen from Table 2, using the method in this application to synthesize the olefin functional polymers, in the premise of no significant reduction in the conversion rate of the functional monomers and the yield of the polymers, by adjusting appropriate process parameters, olefin functional polymers with a weight average molecular weight of 10,000-150,000 can be prepared.

Based on the above examples, it can be seen that the method in this application realized alternating copolymerization of a low-carbon gaseous olefin and a functional monomer both in a same chain through a pressure reaction, and adopted a heterogeneous polymerization mode to improve a monomer concentration and a raw material utilization rate, and synthesized olefin functional polymers with different molecular weights by adjusting process parameters, with a high reaction efficiency; after the polymerization was completed, a relatively stable milky dispersion system can be directly obtained, the post-treatment process was simple, the separation and purification were easy, the raw materials can be recycled, and the conversion rate of the raw materials and the yield of products were improved; and the method was easy to operate, had mild reaction conditions, saved energy consumption, had low costs, and was environmentally friendly.

### 2. Use Based on an Olefin Functional Polymer

The detailed description of the embodiments section in this application provides use based on an olefin functional polymer, including the following steps:
(1) introducing a low-carbon olefin into a reactor, then raising temperature and pressure, and adding a raw material solution prepared by a functional monomer, an initiator and a solvent into the reactor after reaction temperature and reaction pressure are reached to generate a polymerization reaction;
(2) first performing gas-solid-liquid separation on a material after the polymerization reaction in step (1), recovering a low-carbon olefin, and performing solid-liquid separation on a residual material after discharge to obtain a solid-phase olefin functional polymer and a liquid-phase material; and
(3) mixing the olefin functional polymer obtained in step (2) with a matrix resin and a filler to obtain a modified reinforced resin;
subjecting the olefin functional polymer obtained in step (2) and an alcohol to an esterification reaction to obtain an adhesive;
subjecting the olefin functional polymer obtained in step (2) to an anion cation ionization reaction to obtain a scale inhibitor; and
or mixing the olefin functional polymer obtained in step (2) with a coupling agent, a pH regulator and water to obtain a glass fiber impregnating agent.

The following are typical but non-limiting examples of this application:

### Example II-1

This example provided a method of synthesizing an olefin functional polymer, including the following steps:
(1) introducing a low-carbon olefin into a tubular reactor, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the tubular reactor after reaching reaction temperature and reaction pressure, where the functional monomer was maleic anhydride, the initiator was azobisisoheptonitrile, the solvent was n-heptane, a molar ratio of the initiator to the functional monomer was 0.2:1, and a mass ratio of the solvent to the functional monomer was 50:1, and generating a polymerization reaction, where temperature of the polymerization reaction was 60° C., pressure of the polymerization reaction was 5 MPa, residence time was 10 h, and in a process of the polymerization reaction, the low-carbon olefin was continuously introduced to maintain the pressure; and
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing pressure filtration using nitrogen, and an obtained filter cake was washed and dried to obtain a solid-phase olefin functional polymer and a liquid-phase material, where a washing solvent was n-hexane, and the olefin functional polymer was a microspherical particle; and performing rectification separation on the liquid-phase material, and returning a rectified fraction at a column top as a recovered solvent for each component to steps (1) and (2) each for reuse in preparing the raw material solution and washing the filter cake.

### Example I1-2

This example provided a method of synthesizing an olefin functional polymer, including the following steps:
(1) introducing a low-carbon olefin into a microchannel reactor, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the reactor after reaching reaction temperature and reaction pressure, where the functional monomer was maleic anhydride, the initiator was azobisisovaleronitrile, the solvent was ethyl benzoate, a molar ratio of the initiator to the functional monomer was 0.1:1, and a mass ratio of the solvent to the functional monomer was 25:1, and generating a polymerization reaction, where temperature of the polymerization reaction was 90° C., pressure of the polymerization reaction was 10 MPa, residence time was 0.01 h, and in a process of the polymerization reaction, the low-carbon olefin was continuously introduced to maintain the pressure; and
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing pressure filtration using nitrogen, and an obtained filter cake was washed and dried to obtain a solid-phase olefin functional polymer and a liquid-phase material, where a washing solvent was n-hexane, and the olefin functional polymer was a microspherical particle; and performing rectification on the liquid-phase material, and returning a rectified fraction at a column top as a recovered solvent for each component to steps (1) and (2) for reuse in preparing the raw material solution and washing the filter cake.

### Example II-3

This example provided a method of synthesizing an olefin functional polymer, including the following steps:
(1) introducing a low-carbon olefin into a reaction kettle, then raising the temperature and pressure, where the low-carbon olefin was ethylene, and nitrogen was used to replace air before the low-carbon olefin was introduced into the microchannel reactor, pumping a raw material solution prepared by a functional monomer, an initiator and a solvent into the reaction kettle after reaching reaction temperature and reaction pressure, where the functional monomer was maleic anhydride, the initiator was azobisisoheptonitrile, the solvent was isoamyl acetate, a molar ratio of the initiator to the functional monomer was 0.015:1, and a mass ratio of the solvent to the functional monomer was 10:1, and generating a polymerization reaction, where temperature of the polymerization reaction was 110° C., pressure of the polymerization reaction was 3 MPa, residence time was 5 h, and in a process of the polymerization reaction, the low-carbon olefin was continuously introduced to maintain the pressure; and
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing pressure filtration using nitrogen, and an obtained filter cake was dried to obtain a solid-phase olefin functional polymer and a liquid-phase material, where a washing solvent was n-hexane, and the olefin functional polymer was a microspherical particle; and performing distillation on the liquid-phase material, and returning a distilled fraction at a column top as a recovered solvent o step (1) for reuse in preparing the raw material solution.

### Example II-4

This example provided a method of synthesizing an olefin functional polymer, including the following steps:
(1) introducing a low-carbon olefin into a tubular reactor, then raising the temperature and pressure, where the low-carbon olefin was propylene, and nitrogen was used to replace air before the low-carbon olefin was introduced into the microchannel reactor, pumping a raw material solution prepared by a functional monomer, an initiator and a solvent into the tubular reactor after reaching reaction temperature and reaction pressure, where the functional monomer was maleimide, the initiator was diisopropylbenzene peroxide, the solvent was butyl acetate and xylene in a volume ratio of 1:1, a molar ratio of the initiator to the functional monomer was 0.005:1, and a mass ratio of the solvent to the functional monomer was 6:1, and generating a polymerization reaction, where temperature of the polymerization reaction was 120° C., pressure of the polymerization reaction was 2 MPa, residence time was 4 h, and in a process of the polymerization reaction, the low-carbon olefin was continuously introduced to maintain the pressure; and
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing pressure filtration using argon, and an obtained filter cake was washed and dried to obtain a solid-phase olefin functional polymer and a liquid-phase material, where a washing solvent was n-hexane, and the olefin functional polymer was a microspherical particle; and performing rectification separation on the liquid-phase material, and returning a rectified fraction at a column top as a recovered solvent for each component to steps (1) and (2) each for reuse in preparing the raw material solution and washing the filter cake.

### Example II-5

This example provided a method of synthesizing an olefin functional polymer, including the following steps:
(1) introducing a low-carbon olefin into a tubular reactor, then raising the temperature and pressure, where the low-carbon olefin was 1-butene, and nitrogen was used to replace air before the low-carbon olefin was introduced into the microchannel reactor, pumping a raw material solution prepared by a functional monomer, an initiator and a solvent into the tubular reactor after reaching reaction temperature and reaction pressure, where the functional monomer was maleic acid, the initiator was dodecanoyl peroxide, the solvent was ethyl phenylacetate, a molar ratio of the initiator to the functional monomer was 0.08:1, and a mass ratio of the solvent to the functional monomer was 20:1, and generating a polymerization reaction, where temperature of the polymerization reaction was 100° C., pressure of the polymerization reaction was 7 MPa, residence time was 3 h, and in a process of the polymerization reaction, the low-carbon olefin was continuously introduced to maintain the pressure; and
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing pressure filtration using argon, and an obtained filter cake was washed and dried to obtain a solid-phase olefin functional polymer and a liquid-phase material, where a washing solvent was n-hexane, and the olefin functional polymer was a microspherical particle; and performing rectification separation on the liquid-phase material, and returning a rectified fraction at a column top as a recovered solvent for each component to steps (1) and (2) for reuse in preparing the raw material solution and washing the filter cake.

### Example II-6

This example provided a method of synthesizing a ployolefin functional polymer, including the following steps:
(1) introducing a low-carbon olefin into a reaction kettle, then raising the temperature and pressure, where the low-carbon olefin was ethylene and propylene with a molar ratio of 1:1, and nitrogen was used to replace air before the low-carbon olefin was introduced into the microchannel reactor, pumping a raw material solution prepared by a functional monomer, an initiator, an comonomer, and a solvent into the reaction kettle after reaching reaction temperature and reaction pressure, where the functional monomer was maleic anhydride, the initiator was dibenzoyl peroxide, the solvent was cyclohexane and ethyl acetate with a volume ratio of 5:1, the comonomer was vinyl acetate, a molar ratio of the initiator to the functional monomer was 0.15:1, a mass ratio of the solvent to the functional monomer was 35:1, and a molar ratio of the comonomer to the functional monomer was 5:1, and generating a polymerization reaction, where temperature of the polymerization reaction was 80° C., pressure of the polymerization reaction was 6 MPa, residence time was 8 h, and in a process of the polymerization reaction, the low-carbon olefin was continuously introduced to maintain the pressure; and
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing pressure filtration using nitrogen, and an obtained filter cake was washed and dried to obtain a ternary olefin functional polymer and a liquid-phase material, where a washing solvent was propyl ether, and the ternary olefin functional polymer was a microspherical particle; and performing rectification on the liquid-phase material, and returning a rectified fraction at a column top as a recovered solvent for each component to steps (1) and (2) each for reuse in preparing the raw material solution and washing the filter cake.

### Example II-7

This example provided a method of synthesizing an olefin functional polymer, including the following steps:
(1) introducing a low-carbon olefin into a fluidized bed reactor, then raising the temperature and pressure, where the low-carbon olefin was 1-butene, and nitrogen was used to replace air before the low-carbon olefin was introduced into the microchannel reactor, pumping a raw material solution prepared by a functional monomer, an initiator and a solvent into the fluidized bed reactor after reaching reaction temperature and reaction pressure, where the functional monomer was maleic anhydride, the initiator was dimethyl azodiisobutyrate and dodecanoyl peroxide in a molar ratio of 1:1, the solvent was ethyl acetate, a molar ratio of the initiator to the functional monomer was 0.002:1, and a mass ratio of the solvent to the functional monomer was 3:1, and generating a polymerization reaction, where temperature of the polymerization reaction was 150° C., pressure of the polymerization reaction was 0.5 MPa, residence time was 1.5 h, and in a process of the polymerization reaction, the low-carbon olefin was continuously introduced to maintain the pressure; and
the operation of step (2) referred to Example 1.

According to the content detection of raw material monomers and olefin functional polymers before and after the reactions in the above examples, the conversion rate of the functional monomers, and the yield and anhydride value of the olefin functional polymers were calculated, and the molecular weight and particle size of the polymers were tested and calculated. The results are shown in Table 3.

TABLE 3
Result data of polymerization reactions in Examples II-1 to II-7

| | Functional | | | | | |
|---|---|---|---|---|---|---|
| | monomer | | | | | |
| | conversion | Polymer | Anhydride | Molecular | | |
| Example | rate/% | yield/% | value/% | weight | D50/μm | D90/μm |
| Example | 96.44 | 95.48 | 71.06 | 61500 | 16 | 39 |
| II-1 | | | | | | |
| Example | 97.54 | 95.03 | 60.02 | 59600 | 17 | 35 |
| II-2 | | | | | | |
| Example | 95.79 | 95.52 | 70.56 | 28100 | 21 | 40 |
| II-3 | | | | | | |
| Example | 97.15 | 96.11 | 68.58 | 32300 | 13 | 39 |
| II-4 | | | | | | |
| Example | 96.13 | 95.85 | 61.37 | 56700 | 18 | 36 |
| II-5 | | | | | | |
| Example | 86.29 | 92.92 | 11.00 | 48400 | 15 | 38 |
| II-6 | | | | | | |
| Example | 88.34 | 95.22 | 60.56 | 32300 | 12 | 38 |
| II-7 | | | | | | |

As can be seen from Table 1, in the above Examples II-1 to II-5 and II-7, the olefin functional polymers were synthesized by the method using the low-carbon olefins and the functional monomers as raw materials, and the conversion rate of the functional monomers can reach over 88%, and the yield of the polymers can also reach over 95%, the anhydride value of the polymers was over 60%, the molecular weight of the polymers was in the range of 25,000-65,000, and the particle size of the polymers was in the range of 10-50 jam; and in Example 6, when the comonomer was added as a raw material, the anhydride value of the synthesized polyolefin copolymer can be effectively adjusted.

### Application Example 1

This application example used the olefin functional polymer synthesized in Example II-1 as a compatible modifier for preparation of a modified reinforced resin, including the following steps:
mixing the olefin functional polymer as the compatible modifier with matrix resin PA6 and filler glass fiber, where an addition amount of the matrix resin accounted for 67.0 wt % of a total amount of a mixture, an addition amount of the filler accounted for 28.7 wt % of the total amount of mixture, an addition amount of the olefin functional polymer accounted for 4.3 wt % of the total amount of mixture, and a method of the mixing was mechanical blending, which specifically included: initially mixing the olefin functional polymer, the matrix resin and the filler, performing internal mixing in an banbury mixer, with a temperature of the internal mixing at 230° C., and performing extrusion granulation through a twin screw extruder to prepare glass fiber modified and reinforced PA6 resin.

### Application Example 2

This application example used the olefin functional polymer synthesized in Example II-2 as a compatible modifier for preparation of a modified reinforced resin, including the following steps:
mixing the olefin functional polymer as the compatible modifier with matrix resin PET and filler glass fiber, where an addition amount of the matrix resin accounted for 73.6 wt % of a total amount of a mixture, an addition amount of the filler accounted for 18.4 wt % of the total amount of the mixture, an addition amount of the olefin functional polymer accounted for 8 wt % of the total amount of the mixture, and a method of the mixing was solution blending, which specifically included: dissolving the olefin functional polymer, the matrix resin and the filler in N-methylpyrrolidone solvent, removing the solvent by distillation after being uniformly mixed to obtain glass fiber modified and reinforced PET resin.

### Application Example 3

This application example used the olefin functional polymer synthesized in Example II-1 for preparation of an adhesive, including the following steps:
subjecting the olefin functional polymer and methanol to an esterification reaction, where a molar ratio of an anhydride in the olefin functional polymer to methanol was 1:3, a temperature of the esterification reaction was 65° C., and time was 4 h, and performing concentration and drying to obtain an esterification product, which can be used as the adhesive.

### Application Example 4

This application example used the olefin functional polymer synthesized in Example II-3 for preparation of an adhesive, including the following steps:
subjecting the olefin functional polymer and ethanol to an esterification reaction, where a molar ratio of an anhydride in the olefin functional polymer to ethanol was 1:5, a temperature of the esterification reaction was 80° C., and time was 3 h, performing concentration and drying to obtain an esterification product, and then mixing the esterification product with a tackifier, a filler and water by stirring to obtain the adhesive, where the tackifier included diphenylmethane diisocyanate, and the filler included calcium carbonate, a mass ratio of the esterification product, diphenylmethane diisocyanate, calcium carbonate, and water was 10:2:5:40, a stirring rate was 200 r/min, and stirring time was 10 min.

### Application Example 5

This application example used the olefin functional polymer synthesized in Example II-1 for preparation of a scale inhibitor, including the following steps:
subjecting the olefin functional polymer and methanol to an esterification reaction, where a molar ratio of an anhydride in the olefin functional polymer to methanol was 1:5, a temperature of the esterification reaction was 65° C., pressure was 0.13 MPa, and time was 4 h, then performing condensation and phase separation, and performing suction filtration and drying on an extracted ester-containing fraction to obtain a monoesterified polyethylene maleic anhydride; and then mixing the monoesterified polyethylene maleic anhydride with epoxypropyltrimethylammonium chloride and solvent dichloromethane for reaction, adding an alkaline solution of sodium hydroxide at the same time, where a molar ratio of a carboxyl group in the monoesterified polyethylene maleic anhydride to epoxypropyltrimethylammonium chloride was 1:1.5; and a temperature of the reaction was 80° C., and time was 4 h, and after the reaction, removing the solvent by distillation under reduced pressure, and recrystallizing a residual material using a mixed acetone/ethanol solvent and then performing vacuum drying to obtain an amine salt type cationic polymer scale inhibitor.

### Application Example 6

This application example used the olefin functional polymer synthesized in Example 11-4 for preparation of a scale inhibitor, including the following steps:
mixing the olefin functional polymer with a sodium hydroxide solution and then generating a saponification reaction, where a molar ratio of an anhydride in the olefin functional polymer to sodium hydroxide was 1:4, a temperature of the reaction was 120° C., and time was 6 h, and after the reaction, removing water by distillation under reduced pressure, and washing a residual material using cyclohexane and then performing vacuum drying to obtain a carboxylate type anionic polymer scale inhibitor.

### Application Example 7

This application example used the olefin functional polymer synthesized in Example 11-5 for preparation of a scale inhibitor, including the following steps:
subjecting the olefin functional polymer and ethylene glycol to an esterification reaction, where a molar ratio of an anhydride in the olefin functional polymer to ethylene glycol was 1:2, a temperature of the esterification reaction was 75° C., pressure was 0.4 MPa, and time was 4.5 h, then performing condensation and phase separation, and performing suction filtration and drying on an extracted ester-containing fraction to obtain a monoesterified polyethylene maleic anhydride; and
dissolving the monoesterified polyethylene maleic anhydride in dichloromethane, then adding concentrated sulfuric acid for reaction, where a molar ratio of a hydroxyl group in the monoesterified polypropylene maleic anhydride to sulfuric acid was 1:2; and a temperature of the reaction was 80° C., and time was 2 h, and after the reaction, adding a sodium hydroxide solution to adjust pH to 7, removing dichloromethane by distillation under reduced pressure, drying and pulverizing a residual material to obtain a sulfate type anionic polymer scale inhibitor.

### Application Example 8

This application example used the olefin functional polymer synthesized in Example 11-5 for preparation of a glass fiber impregnating agent, including the following steps:
mixing the olefin functional polymer with coupling agent A-151, lubricant stearicamide, defoamer polyoxypropylene glycerol ether, and water, where a mass fraction of water was 95%, and remaining components were calculated by mass fraction, including 80% of the ternary olefin functional polymer, 10% of the coupling agent, 5% of the lubricant, and 5% of the defoamer, which specifically included first adding the coupling agent to water and stirring for 25 min, then adding the lubricant, the ternary olefin functional polymer and the defoamer and stirring for 60 min at a stirring rate of 800 rpm to finally obtain the glass fiber impregnating agent.

### Application Example 9

This application example used the ternary olefin functional polymer synthesized in ExampleII-6 for preparation of a glass fiber impregnating agent, including the following steps: mixing the ternary olefin functional polymer with coupling agent KH570, pH regulator aqueous ammonia, lubricant oleamide, defoamer polyoxyethylene polyoxypropylene pentaerythritol ether, antioxidant 1076, and water, where a mass fraction of water was 80%, and remaining components were calculated by mass fraction, including 70% of the ternary olefin functional polymer, 20% of the coupling agent, 5% of the defoamer, 1% of the antioxidant, and 4% of the pH regulator, which specifically included first adding the coupling agent to water and stirring for 30 min, then adding the lubricant, the ternary olefin functional polymer, the defoamer, and the antioxidant and stirring for 80 min at a stirring rate of 600 rpm, and then adding the pH adjuster to adjust a pH value to 9 to obtain the glass fiber impregnating agent.

According to the above application examples, it can be seen that the olefin functional polymer synthesized by the examples can further undergo reactions and can be used to prepare modified reinforced resins, adhesives, scale inhibitors, and glass fiber impregnating agents, achieving multi field applications, and the performance of the products meets the standards of corresponding types of products.

Based on the above examples, it can be seen that this application realizes alternating copolymerization of the low-carbon gaseous olefins and the liquid functional monomers in a same chain through the pressure reaction of the two by adopting a heterogeneous polymerization method, and can obtain the olefin functional polymers with a high functional group content, high reactivity and wide application; by continuously feeding the raw material solutions, the concentrations of the monomers and the initiators in the reactions can be regulated in real time, improving the concentration of the monomers and the utilization rate of the raw materials and regulating the molecular weight of the olefin functional polymers; and using the olefin functional polymers as reaction platforms, various modified materials suitable for different fields were prepared through chemical reactions such as esterification, hydrolysis and modification, and various downstream products were developed, expanding the application range of the olefin functional polymers; and this application had a simple operation process, mild reaction conditions, easy separation and purification, and recyclable raw materials, saved energy consumption, and had low costs and high economic benefits.

This application illustrates the detailed method of this application through the above examples, but this application is not limited to the above detailed methods, which does not mean that this application must rely on the above detailed methods to be implemented. It should be understood by those skilled in the art that any improvements made to this application as well as equivalent replacements of the methods, addition of auxiliary steps and selection of specific methods, etc. in this application fall within the scope of protection and disclosure of this application.

1. A method of synthesizing an olefin functional polymer in a continuous feeding manner, comprising the following steps:
(1) introducing a low-carbon olefin into a reactor, then raising temperature and pressure, and adding a raw material solution prepared by a functional monomer, an initiator and a solvent into the reactor in the continuous feeding manner after reaction temperature and reaction pressure are reached to generate a polymerization reaction; and
(2) first performing gas-solid-liquid separation on a system after the polymerization reaction in step (1), recovering a low-carbon olefin, returning a discharged low-carbon olefin to step (1) for reuse, and performing solid-liquid separation on a residual material after discharge to obtain a solid-phase olefin functional polymer and a liquid-phase material.

2. The method according to claim 1, wherein the low-carbon olefin in step (1) comprises any one or a combination of at least two of ethylene, propylene, butene, or butadiene; and
preferably, before introducing the low-carbon olefin in step (1), the reactor is evacuated and then replaced with a protective gas.

3. The method according to claim 1, wherein the reactor in step (1) comprises any one of a reaction kettle, a tubular reactor, a microchannel reactor, a fluidized bed reactor, or a boiling bed reactor;
preferably, the tubular reactor comprises any one of a horizontal tubular reactor, a vertical tubular reactor, a coiled tubular reactor, or a U-shaped tubular reactor; and
preferably, the microchannel reactor comprises a gas-liquid-solid three-phase catalytic microreactor.

4. The method according to claim 1, wherein the functional monomer in step (1) comprises any one or a combination of at least two of maleic anhydride, maleimide or maleic acid;
preferably, the initiator in step (1) comprises an azo compound and/or a peroxide compound;
preferably, the azo compound comprises any one or a combination of at least two of azodiisobutyronitrile, azobisisovaleronitrile, azobisisoheptonitrile, azodicyclohexylformonitrile, or dimethyl azodiisobutyrate;
preferably, the peroxide compound comprises any one or a combination of at least two of dibenzoyl peroxide, dicumyl peroxide, diisopropyl peroxydicarbonate, diisobutyryl peroxide, bis(2,4-dichlorobenzoyl) peroxide, dodecanoyl peroxide, or tert-butyl peroxyneoheptanoate;
preferably, the solvent in step (1) comprises any one or a combination of at least two of an organic alkanoate compound, an alkane compound or an aromatic hydrocarbon compound;
preferably, a structural formula of the organic alkanoate compound is 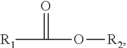
wherein R1 is any one of H, a C1-C20 alkane group or a C6-C10 aryl group, and R2 is any one of a C1-C20 alkane group or a C6-C10 aryl group;
preferably, the alkane hydrocarbon compound comprises any one or a combination of at least two of n-hexane, cyclohexane, n-pentane, n-heptane, n-octane, or n-decane; and
preferably, the aromatic hydrocarbon compound comprises any one or a combination of at least two of benzene, toluene, ethylbenzene, or xylene.

5. The method according to claim 1, wherein a molar ratio of the initiator to the functional monomer in step (1) is (0.001-0.2):1, preferably (0.001-0.03):1;
preferably, a mass ratio of the solvent to the functional monomer in step (1) is (2-50):1, preferably (2-10):1;
preferably, before adding the raw material solution into the reactor in step (1), impurity removal and preheating are performed; and
preferably, the raw material solution in step (1) is pumped into the reactor at a constant speed after being pressurized by a transfer pump.

6. The method according to claim 1, wherein a temperature of the polymerization reaction in step (1) is 50-150° C., preferably 70-120° C.;
preferably, pressure of the polymerization reaction in step (1) is 0.1-10 MPa, preferably 2-8 MPa;
preferably, feeding time of the raw material solution in step (1) is 0.1-10 h;
preferably, residence time of the raw material solution in step (1) is 0.1-15 h; and
preferably, in a process of the polymerization reaction in step (1), the low-carbon olefin is continuously introduced to maintain the pressure.

7. The method according to claim 1, wherein in a process of the gas-solid-liquid separation in step (2), the low-carbon olefin is discharged for recovery and replaced with the protective gas;
preferably, the residual material after recovering the low-carbon olefin in step (2) is discharged in a solid-liquid manner.

8. The method according to claim 1, wherein a method of the solid-liquid separation in step (2) comprises any one or a combination of at least two of decantation, filtration or centrifugation;
preferably, the filtration comprises any one of gravity filtration, vacuum filtration or pressure filtration;
preferably, the residual material is subjected to the pressure filtration using the protective gas, and an obtained filter cake is washed, dried and then crushed;
preferably, the washing is performed using the solvent in step (1);
preferably, the solvent used for the washing further comprises an ether compound, the ether compound comprising any one or a combination of at least two of C1-C10 saturated ether compounds, preferably diethyl ether and/or propyl ether;
preferably, a temperature is 30-150° C., time is 1-72 h, and pressure is 0.1-101 kPa for the drying; and
preferably, the olefin functional polymer in step (2) is a microspherical particle with a particle size of 10-50 m.

9. The method according to claim 1, wherein the liquid-phase material in step (2) is separated, and an obtained recovered solvent is returned to step (1) for reuse;
preferably, a method of separating the liquid phase material comprises any one or a combination of at least two of distillation, membrane separation, washing, or extraction, preferably distillation.

10. The method according to claim 1, comprising the following steps:
(1) introducing the low-carbon olefin into the reactor, then raising the temperature and pressure, wherein the low-carbon olefin comprises any one or a combination of at least two of ethylene, propylene, butene, or butadiene, and the reactor comprises any one of the reaction kettle, the tubular reactor, the microchannel reactor, the fluidized bed reactor, or the boiling bed reactor, adding the raw material solution prepared by the functional monomer, the initiator and the solvent into the reactor in the continuous feeding manner after the reaction temperature and the reaction pressure are reached, wherein the functional monomer comprises any one or a combination of at least two of maleic anhydride, maleimide or maleic acid, the initiator comprises the azo compound and/or the peroxide compound, the solvent comprises any one or a combination of at least two of the organic alkanoate compound, the alkane compound or the aromatic hydrocarbon compound, the molar ratio of the initiator to the functional monomer is (0.001-0.2):1, the mass ratio of the solvent to the functional monomer is (2-50):1, and pumping the raw material solution into the reactor at the constant speed after being pressurized by the transfer pump to generate the polymerization reaction, wherein the temperature of the polymerization reaction is 50-150° C., the pressure of the polymerization reaction is 0.1-10 MPa, the feeding time is 0.1-10 h, the residence time is 0.1-15 h, and in the process of the polymerization reaction, the low-carbon olefin is continuously introduced to maintain the pressure;
(2) first performing the gas-solid-liquid separation on the system after the polymerization reaction in step (1), wherein in the process of the gas-solid-liquid separation, a residual low-carbon olefin is discharged and replaced with the protective gas, pressurizing the discharged low-carbon olefin and then returning it to step (1) for reuse, discharging the residual material in the solid-liquid manner and performing the solid-liquid separation, performing the pressure filtration on the residual material using the protective gas, and an obtained filter cake was washed, dried and then crushed to obtain the solid-phase olefin functional polymer and the liquid-phase material, and drying and then crushing the obtained filter cake to obtain the solid-phase olefin functional polymer and the liquid-phase material, wherein the olefin functional polymer is the microspherical particle with the particle size of 10-50 m; and
(3) separating the liquid-phase material obtained in step (2), wherein the method of the separation comprises any one or a combination of at least two of distillation, membrane separation, washing, or extraction, and returning the obtained recovered solvent to step (1) and/or step (2) for reuse for preparing the raw material solution and/or washing the filter cake.

11. Use based on an olefin functional polymer, wherein the olefin functional polymer is the olefin functional polymer obtained by the method according to claim 1, and the olefin functional polymer is mixed with a matrix resin and a filler to obtain a modified reinforced resin;
preferably, the olefin functional polymer is mixed with the matrix resin and the filler as a compatible modifier;
preferably, the matrix resin comprises a thermoplastic resin and/or a thermosetting resin;
preferably, the thermoplastic resin comprises any one or a combination of at least two of PC, PA, POM, PBT, PET, PVC, PS, PE, or ABS;
preferably, the thermosetting resin comprises any one or a combination of at least two of EP, UPR, PU, or UF;
preferably, the filler comprises an inorganic filler and/or an organic filler;
preferably, an addition amount of the matrix resin accounts for 30-90 wt % of a total amount of a mixture, an addition amount of the filler accounts for 5-65 wt % of the total amount of the mixture, and an addition amount of the olefin functional polymer accounts for 3-15 wt % of the total amount of the mixture; and
preferably, a method of the mixing comprises any one of mechanical blending, solution blending or latex blending.

12. Use based on an olefin functional polymer, wherein the olefin functional polymer is the olefin functional polymer obtained by the method according to claim 1, and the olefin functional polymer is subjected to an esterification reaction with an alcohol to obtain an adhesive;
preferably, the alcohol comprises any one or a combination of at least two of methanol, ethanol, propanol, or butanol;
preferably, a molar ratio of an anhydride in the olefin functional polymer to the alcohol is 1:(2-5);
preferably, a temperature of the esterification reaction is 60-80° C.;
preferably, time of the esterification reaction is 3-5 h; and
preferably, after the esterification reaction, an esterification product is obtained by concentration and drying.

13. Use based on an olefin functional polymer, wherein the olefin functional polymer is the olefin functional polymer obtained by the method according to claim 1, and the olefin functional polymer is subjected to an anion cation ionization reaction to obtain a scale inhibitor;
preferably, before the anion cation ionization reaction, an esterification reaction between the olefin functional polymer and an alcohol is further comprised to generate a monoesterified olefin functional polymer;
preferably, the alcohol comprises any one or a combination of at least two of methanol, ethanol, butanol, ethylene glycol, or propylene glycol;
preferably, the anion cation ionization reaction comprises a reaction between the olefin functional polymer or monoesterified olefin functional polymer and a quaternary ammonium salt, a base or an acid;
preferably, the quaternary ammonium salt comprises any one or a combination of at least two of epoxypropyltrimethylammonium chloride, octadecyldimethylammonium chloride, an octadecylamine polyoxyethylene ether diquaternary ammonium salt, or an didodecylamine polyoxyethylene ether monoquaternary ammonium salt;
preferably, the base comprises a caustic alkali, added in a form of an alkaline solution;
preferably, the acid comprises any one or a combination of at least two of sulfuric acid, persulfuric acid or phosphorus pentoxide; and
preferably, the anion cation ionization reaction comprises any one or a combination of at least two of an reaction between the monoesterified olefin functional polymer and the quaternary ammonium salt in an alkaline solution to prepare a cationic polymer scale inhibitor, an reaction between the olefin functional polymer and the quaternary ammonium salt in the alkaline solution to prepare a cationic polymer scale inhibitor, a saponification reaction between the olefin functional polymer and the alkaline solution to prepare a carboxylate type anionic polymer scale inhibitor, a reaction between a diol monoesterified olefin functional polymer and sulfuric acid to prepare a sulfate type anionic polymer scale inhibitor, or a reaction between the diol monoesterified olefin functional polymer and phosphorus pentoxide to prepare a phosphate type anionic polymer scale inhibitor.

14. Use based on an olefin functional polymer, wherein the olefin functional polymer is the olefin functional polymer obtained by the method according to claim 1, and the olefin functional polymer is mixed with a coupling agent, a pH regulator and water to obtain a glass fiber impregnating agent;
preferably, the coupling agent comprises any one or a combination of at least two of a silane coupling agent, an aluminate coupling agent or a titanate coupling agent;
the pH regulator comprises an acid regulator or a base regulator;
preferably, the acid regulator comprises any one or a combination of at least two of acetic acid, citric acid, formic acid, or oxalic acid;
preferably, the base regulator comprises any one or a combination of at least two of aqueous ammonia, sodium hydroxide, sodium bicarbonate, a basic amino acid or an organic amine;
preferably, preparation steps of the glass fiber impregnating agent comprise: first adding the coupling agent to water for stirring, then adding the olefin functional polymer, stirring evenly, and then adding the pH regulator to obtain the glass fiber impregnating agent;
preferably, stirring time after adding the coupling agent is 20-30 min;
preferably, stirring time is 60-240 min, and a stirring rate is 100-800 rpm after adding the olefin functional polymer;
preferably, a pH value is adjusted to 6-10 after adding the pH regulator;
preferably, a mass proportion of water in the glass fiber impregnating agent is 20-95 wt %, and a remaining portion is a solid-phase component;
preferably, the glass fiber impregnating agent further comprises any one or a combination of at least two of a lubricant, a defoamer or an antioxidant; and
preferably, timing for adding the lubricant, defoamer, and antioxidant in preparation of the glass fiber impregnating agent is: to be added together with a polyolefin functional polymer.

15. Use based on the olefin functional polymer according to claim 11, the use comprises the following steps:
(1) introducing a low-carbon olefin into a reactor, then raising temperature and pressure, wherein the low-carbon olefin comprises any one or a combination of at least two of ethylene, propylene, butene, or butadiene, and the reactor comprises any one of a tank reactor, a tubular reactor, a microchannel reactor, a tower reactor, a fluidized bed reactor, or a boiling bed reactor, adding a raw material solution prepared by a functional monomer, an initiator and a solvent into the reactor after reaction temperature and reaction pressure are reached, wherein the functional monomer comprises any one or a combination of at least two of maleic anhydride, maleimide or maleic acid, the initiator comprises an azo compound and/or a peroxide compound, the solvent comprises any one or a combination of at least two of an organic alkanoate compound, an alkane compound or an aromatic hydrocarbon compound, a molar ratio of the initiator to the functional monomer is (0.001-0.2):1, a mass ratio of the solvent to the functional monomer is (2-50):1, and pumping the raw material solution into the reactor at a constant speed after being pressurized by a transfer pump to generate a polymerization reaction, wherein a temperature of the polymerization reaction is 50-150° C., pressure of the polymerization reaction is 0.1-10 MPa, residence time is 10 s-10 h, and in a process of the polymerization reaction, the low-carbon olefin is continuously introduced to maintain the pressure;
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing solid-liquid separation, performing pressure filtration using a protective gas, and an obtained filter cake was washed and dried to obtain a solid-phase olefin functional polymer and a liquid-phase material, wherein the olefin functional polymer is a microspherical particle with a particle size of 10-50 m; separating the liquid-phase material, wherein a method of the separation comprises any one or a combination of at least two of distillation, membrane separation, washing, or extraction, returning a separated recovered solvent to step (1) and/or step (2) for reuse, and preparing the raw material solution and/or washing the filter cake;
(3) mixing the olefin functional polymer obtained in step (2) with a matrix resin and a filler as a compatible modifier to obtain a modified reinforced resin, wherein the matrix resin comprises a thermoplastic resin and/or a thermosetting resin, the filler comprises an inorganic filler and/or an organic filler, an addition amount of the matrix resin accounts for 30-90 wt % of a total amount of a mixture, an addition amount of the filler accounts for 5-65 wt % of the total amount of the mixture, and an addition amount of the olefin functional polymer accounts for 3-15 wt % of the total amount of the mixture, a method of the mixing comprises any one of mechanical blending, solution blending or latex blending.

16. Use based on the olefin functional polymer according to claim 12, the use comprises the following steps:
(1) introducing a low-carbon olefin into a reactor, then raising temperature and pressure, wherein the low-carbon olefin comprises any one or a combination of at least two of ethylene, propylene, butene, or butadiene, and the reactor comprises any one of a tank reactor, a tubular reactor, a microchannel reactor, a tower reactor, a fluidized bed reactor, or a boiling bed reactor, adding a raw material solution prepared by a functional monomer, an initiator and a solvent into the reactor after reaction temperature and reaction pressure are reached, wherein the functional monomer comprises any one or a combination of at least two of maleic anhydride, maleimide or maleic acid, the initiator comprises an azo compound and/or a peroxide compound, the solvent comprises any one or a combination of at least two of an organic alkanoate compound, an alkane compound or an aromatic hydrocarbon compound, a molar ratio of the initiator to the functional monomer is (0.001-0.2):1, a mass ratio of the solvent to the functional monomer is (2-50):1, and pumping the raw material solution into the reactor at a constant speed after being pressurized by a transfer pump to generate a polymerization reaction, wherein a temperature of the polymerization reaction is 50-150° C., pressure of the polymerization reaction is 0.1-10 MPa, residence time is 10 s-10 h, and in a process of the polymerization reaction, the low-carbon olefin is continuously introduced to maintain the pressure;
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing solid-liquid separation, performing pressure filtration using a protective gas, and an obtained filter cake was washed and dried to obtain a solid-phase olefin functional polymer and a liquid-phase material, wherein the olefin functional polymer is a microspherical particle with a particle size of 10-50 m; separating the liquid-phase material, wherein a method of the separation comprises any one or a combination of at least two of distillation, membrane separation, washing, or extraction, returning a separated recovered solvent to step (1) and/or step (2) for reuse, and preparing the raw material solution and/or washing the filter cake;
subjecting the olefin functional polymer obtained in step (2) and an alcohol to an esterification reaction, wherein the alcohol comprises any one or a combination of at least two of methanol, ethanol, propanol, or butanol, a molar ratio of an anhydride in the olefin functional polymer to the alcohol is 1:(2-5), a temperature of the esterification reaction is 60-80° C., and time of the esterification reaction is 3-5 h, and then performing concentration and drying to obtain an adhesive.

17. Use based on the olefin functional polymer according to claim 13, the use comprises the following steps:
(1) introducing a low-carbon olefin into a reactor, then raising temperature and pressure, wherein the low-carbon olefin comprises any one or a combination of at least two of ethylene, propylene, butene, or butadiene, and the reactor comprises any one of a tank reactor, a tubular reactor, a microchannel reactor, a tower reactor, a fluidized bed reactor, or a boiling bed reactor, adding a raw material solution prepared by a functional monomer, an initiator and a solvent into the reactor after reaction temperature and reaction pressure are reached, wherein the functional monomer comprises any one or a combination of at least two of maleic anhydride, maleimide or maleic acid, the initiator comprises an azo compound and/or a peroxide compound, the solvent comprises any one or a combination of at least two of an organic alkanoate compound, an alkane compound or an aromatic hydrocarbon compound, a molar ratio of the initiator to the functional monomer is (0.001-0.2):1, a mass ratio of the solvent to the functional monomer is (2-50):1, and pumping the raw material solution into the reactor at a constant speed after being pressurized by a transfer pump to generate a polymerization reaction, wherein a temperature of the polymerization reaction is 50-150° C., pressure of the polymerization reaction is 0.1-10 MPa, residence time is 10 s-10 h, and in a process of the polymerization reaction, the low-carbon olefin is continuously introduced to maintain the pressure;
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing solid-liquid separation, performing pressure filtration using a protective gas, and an obtained filter cake was washed and dried to obtain a solid-phase olefin functional polymer and a liquid-phase material, wherein the olefin functional polymer is a microspherical particle with a particle size of 10-50 m; separating the liquid-phase material, wherein a method of the separation comprises any one or a combination of at least two of distillation, membrane separation, washing, or extraction, returning a separated recovered solvent to step (1) and/or step (2) for reuse, and preparing the raw material solution and/or washing the filter cake;
subjecting the olefin functional polymer obtained in step (2) to an anion cation ionization reaction to obtain a scale inhibitor, wherein before the anion cation ionization reaction, an esterification reaction between the olefin functional polymer and the alcohol is further comprised to generate a monoesterified olefin functional polymer, the alcohol comprises any one or a combination of at least two of methanol, ethanol, butanol, ethylene glycol, or propylene glycol; the anion cation ionization reaction comprises a reaction between the olefin functional polymer or monoesterified olefin functional polymer and a quaternary ammonium salt, a base or an acid, the quaternary ammonium salt comprises any one or a combination of at least two of epoxypropyltrimethylammonium chloride, octadecyldimethylammonium chloride, an octadecylamine polyoxyethylene ether diquaternary ammonium salt, or an didodecylamine polyoxyethylene ether monoquaternary ammonium salt; and the anion cation ionization reaction comprises any one or a combination of at least two of an reaction between the monoesterified olefin functional polymer and the quaternary ammonium salt in an alkaline solution to prepare a cationic polymer scale inhibitor, an reaction between the olefin functional polymer and the quaternary ammonium salt in the alkaline solution to prepare a cationic polymer scale inhibitor, a saponification reaction between the olefin functional polymer and the alkaline solution to prepare a carboxylate type anionic polymer scale inhibitor, a reaction between a diol monoesterified olefin functional polymer and sulfuric acid to prepare a sulfate type anionic polymer scale inhibitor, or a reaction between the diol monoesterified olefin functional polymer and phosphorus pentoxide to prepare a phosphate type anionic polymer scale inhibitor.

18. Use based on the olefin functional polymer according to claim 14, the use comprises the following steps:
(1) introducing a low-carbon olefin into a reactor, then raising temperature and pressure, wherein the low-carbon olefin comprises any one or a combination of at least two of ethylene, propylene, butene, or butadiene, and the reactor comprises any one of a tank reactor, a tubular reactor, a microchannel reactor, a tower reactor, a fluidized bed reactor, or a boiling bed reactor, adding a raw material solution prepared by a functional monomer, an initiator and a solvent into the reactor after reaction temperature and reaction pressure are reached, wherein the functional monomer comprises any one or a combination of at least two of maleic anhydride, maleimide or maleic acid, the initiator comprises an azo compound and/or a peroxide compound, the solvent comprises any one or a combination of at least two of an organic alkanoate compound, an alkane compound or an aromatic hydrocarbon compound, a molar ratio of the initiator to the functional monomer is (0.001-0.2):1, a mass ratio of the solvent to the functional monomer is (2-50):1, and pumping the raw material solution into the reactor at a constant speed after being pressurized by a transfer pump to generate a polymerization reaction, wherein a temperature of the polymerization reaction is 50-150° C., pressure of the polymerization reaction is 0.1-10 MPa, residence time is 10 s-10 h, and in a process of the polymerization reaction, the low-carbon olefin is continuously introduced to maintain the pressure;
(2) first performing gas-solid-liquid separation on a material after the polymerization reaction in step (1), recovering a low-carbon olefin, returning a discharged low-carbon olefin after being pressurized to step (1) for reuse, discharging a residual material in a solid-liquid manner, then performing solid-liquid separation, performing pressure filtration using a protective gas, and an obtained filter cake was washed and dried to obtain a solid-phase olefin functional polymer and a liquid-phase material, wherein the olefin functional polymer is a microspherical particle with a particle size of 10-50 m; separating the liquid-phase material, wherein a method of the separation comprises any one or a combination of at least two of distillation, membrane separation, washing, or extraction, returning a separated recovered solvent to step (1) and/or step (2) for reuse, and preparing the raw material solution and/or washing the filter cake;
mixing the olefin functional polymer obtained in step (2) with a coupling agent, a pH regulator and water, specifically comprising: first adding the coupling agent to water and stirring for 20-30 min, then adding a lubricant, the olefin functional polymer, a defoamer, and an antioxidant and stirring for 60-240 min at a stirring rate of 100-800 rpm, and then adding the pH regulator with a pH value adjusted to 6-10 to obtain a glass fiber impregnating agent, wherein the coupling agent comprises any one or a combination of at least two of a silane coupling agent, an aluminate coupling agent or a titanate coupling agent, the pH regulator comprises an acid regulator or a base regulator, and a mass proportion of water in the glass fiber impregnating agent is 20-95 wt %, and a remaining portion is a solid-phase component.

19. The method according to claim 9, wherein the recovered solvent is returned to step (1) and/or step (2) for reuse for preparing the raw material solution and/or washing the filter cake.

20. The method according to claim 7, the discharged low-carbon olefin is pressurized and then returned to step (1) for reuse.
